(19) United States
(12) Patent Application Publication
(10) Pub. No.: US 2026/0359155 A1
(43) Pub. Date: Nov. 12, 2026

(54) SYSTEMS AND METHODS FOR RESOLVING INCONSISTENCY WITHIN AN INFORMATION STRUCTURE

(71) Applicant: David David, North Hills, CA (US)

(72) Inventor: David David, North Hills, CA (US)

(21) Appl. No.: 19/670,711

(22) Filed: May 7, 2026

Related U.S. Application Data
(60) Provisional application No. 63/801,169, filed on May 7, 2025.
(60) Provisional application No. 64/006,189, filed on Mar. 15, 2026.

(51) Int. Cl. G06F 11/07

(52) U.S. Cl. CPC G06F 11/0751; G06F 11/0715

(57) ABSTRACT

A processor-implemented or computer-implemented method and system resolve inconsistency within an evolving information structure through coupled state-transition processing. A machine-processable information structure is formed from elements and relationships, and at least one inconsistency is detected under a defined incompatibility condition. Under defined process conditions, a permitted subset of candidate transformations is determined with respect to an inconsistency measure. The same information structure, incompatibility condition, inconsistency measure, permitted subset, selected transformation, updated structure, and termination status are coupled across detection, candidate testing, selection, application, updating, iteration, and output. At least one candidate transformation that reduces the inconsistency measure is selected from the permitted subset and applied to modify the information structure. The coupled process repeats until no further permitted reducing transformation remains available. In some embodiments, a state-transition trace record identifies detected inconsistency, tested candidate transformations, before-and-after measures, reduction value, permitted subset, selected transformation, updated structure, and termination status.

### CROSS-REFERENCE TO RELATED APPLICATIONS

This application claims the benefit of U.S. Provisional Application No. 63/801,169, filed May 7, 2025, and U.S. Provisional Application No. 64/006,189, filed March 15, 2026, both of which are hereby incorporated by reference, to the extent that they are not conflicting with the present application.

### BACKGROUND OF INVENTION

### 1. Field of the Invention

The present disclosure relates to processor-implemented or computer-implemented information processing and, more particularly, to methods and systems for resolving inconsistency within an information structure.

### 2. Description of the Related Art

Computer systems or processor-based systems may operate over structured collections of elements, including propositions, constraints, and state descriptors, together with relationships among those elements. In some environments, inconsistencies may arise within such structures.

The present disclosure addresses processor-implemented or computer-implemented processing of an information structure in which at least one inconsistency is detected, and one or more transformations are applied to modify the structure.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one aspect, the disclosure provides a processor-implemented or computer-implemented method for resolving inconsistency within an information structure.

In another aspect, the disclosure provides a system including memory storing an information structure and a processor configured to process that information structure to resolve inconsistency.

In some aspects, the disclosure further provides a processor-implemented or computer-implemented method for generating a traceable inconsistency-resolution record within an inconsistency-resolution process. The trace record may identify a detected inconsistency, an inconsistency measure before transformation, candidate transformations tested using test representations of the information structure, post-transformation inconsistency measures, the permitted subset, the selected transformation, the modified information structure, and a termination status.

Additional aspects are set forth in the claims. The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 depicts a schematic diagram of an exemplary information structure, according to an aspect.

FIG. 2 depicts a flow diagram of an exemplary process for resolving inconsistency within an information structure, according to an aspect.

FIG. 3 depicts a schematic diagram illustrating an exemplary input structure and an exemplary modified structure, according to an aspect.

FIG. 4 depicts a sequence diagram illustrating an exemplary evolution of an information structure, according to an aspect.

FIG. 5 depicts a diagram illustrating exemplary progression of an inconsistency measure under disclosed conditions, according to an aspect.

FIG. 6 depicts a schematic diagram illustrating an exemplary state-transition trace record generated during an inconsistency-resolution process, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by a person of ordinary skill in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by a person of ordinary skill in the art.

### Glossary/Definitions

### Information Structure

Positive definition: A structured arrangement of elements and relationships in machine-processable form over which inconsistency may be detected and resolved. ⋅Negative boundary: Not an unstructured body of text, unrelated data collection, or random collection of values lacking defined structural relationships. ⋅Minimum structural content: A plurality of elements and at least one basis for identifying relationships among them. ⋅Excluded cases: Pure narrative content, isolated data points with no relationship basis, and collections lacking any defined incompatibility condition.

### Element

Positive definition: A unit within an information structure corresponding to a proposition, constraint, state descriptor, or other defined structural item. ⋅Negative boundary: Not a meaningless token or decorative label lacking structural role in the information structure. ⋅Minimum structural content: A distinguishable item capable of participating in at least one relationship or inconsistency determination. ⋅Excluded cases: Formatting marks, irrelevant metadata, and items external to the information structure.

### Relationship

Positive definition: A defined association, dependency, logical relation, or constraint relation among elements within the information structure. ⋅Negative boundary: Not mere physical adjacency, presentation order, or accidental co-occurrence. ⋅Minimum structural content: A basis for determining how one element bears on another within the structure. ⋅Excluded cases: Arbitrary grouping without structural meaning and incidental arrangement without defined relevance.

### Inconsistency

Positive definition: A condition in which two or more elements of the information structure cannot simultaneously be satisfied under a defined incompatibility condition. ⋅Negative boundary: Not simple difference, variety, incompleteness, or uncertainty absent defined incompatibility. ⋅Minimum structural content: At least two elements and a defined incompatibility condition under which simultaneous satisfaction fails. ⋅Excluded cases: Mere disagreement in presentation, optional alternatives, and underdetermined states not defined as incompatible.

### Incompatibility Condition

Positive definition: A defined condition used to determine when simultaneous satisfaction of two or more elements is not permitted within the information structure. ⋅Negative boundary: Not an unstated intuition of conflict or a purely subjective judgment. ⋅Minimum structural content: A criterion capable of distinguishing compatible from incompatible combinations of elements. ⋅Excluded cases: Ad hoc preference, aesthetic disfavor, and undefined conflict judgments.

### Candidate Transformation

Positive definition: A defined modification of the information structure capable of changing one or more elements or relationships in response to identified inconsistency. ⋅Negative boundary: Not an arbitrary edit unrelated to the inconsistency-resolution process. ⋅Minimum structural content: A modification operation applicable to the current information structure. ⋅Excluded cases: Commentary, observation, or non-operative actions outside the structure.

### Admissibility Criterion

Positive definition: The criterion used to determine whether a candidate transformation is permitted for use in resolving detected inconsistency. ⋅Negative boundary: Not unconstrained selection, arbitrary preference, or undefined choice. ⋅Minimum structural content: A basis for distinguishing permitted from non-permitted candidate transformations. ⋅Excluded cases: Random selection, purely aesthetic ranking, and criteria unrelated to inconsistency reduction.

### Inconsistency Measure

Positive definition: A bounded function defined over the information structure for evaluating the inconsistency state of the structure. ⋅Negative boundary: Not an undefined notion of improvement or an unbounded subjective score. ⋅Minimum structural content: A function capable of evaluation on the information structure before and after transformation. ⋅Excluded cases: Pure rhetorical severity labels and measures unrelated to inconsistency.

### Normalized Inconsistency Measure

⋅Positive definition: A bounded representation of the inconsistency measure on a defined scale, such as a scale from 0 to 100, where 0 indicates that no active inconsistency is detected under the defined incompatibility conditions and 100 indicates a maximum or reference inconsistency value under a defined reference scale for the embodiment. ⋅Negative boundary: Not a subjective confidence score, rhetorical severity label, or unbounded qualitative assessment. ⋅Minimum structural content: A defined reference value or normalization basis and an inconsistency measure capable of comparison before and after transformation. ⋅Excluded cases: Scores unrelated to detected incompatibility-condition violations or incapable of determining reduction under the defined process conditions.

### Reduction Value

⋅Positive definition: A value representing a difference between an inconsistency measure of a current information structure and a post-transformation inconsistency measure calculated for a test information structure produced by applying a candidate transformation. ⋅Negative boundary: Not an arbitrary preference score or selection criterion unrelated to reduction of the inconsistency measure. ⋅Minimum structural content: A before-transformation inconsistency measure, a post-transformation inconsistency measure, and a comparison indicating whether the candidate transformation reduces inconsistency. ⋅Excluded cases: Selection preferences unrelated to reduction of the inconsistency measure.

### Termination Status

⋅Positive definition: Data associated with a resulting information structure indicating a condition under which the disclosed process terminated. ⋅Negative boundary: Not an arbitrary label unrelated to the process. ⋅Minimum structural content: An indication that the resulting information structure is resolved when no active inconsistency remains, or stable with remaining inconsistency when no further permitted candidate transformation that reduces the inconsistency measure remains available under the defined process conditions. ⋅Excluded cases: External interruption labels, manual stop labels, or status values unrelated to the disclosed termination condition.

### Termination Condition

Positive definition: The condition under which the iterative process stops because no further permitted candidate transformation that reduces the inconsistency measure remains available under the defined process conditions. ⋅Negative boundary: Not arbitrary stopping, timeout, or user interruption unrelated to the claimed process. ⋅Minimum structural content: A defined stopping state tied to the availability of further permitted candidate transformations that reduce the inconsistency measure under the defined process conditions. ⋅Excluded cases: External interruption, manual override, and non-process-based halt events.

### Stable Result

Positive definition: A resulting information structure produced at termination under the defined process conditions. ⋅Negative boundary: Not a temporary intermediate state or provisional state pending further process iterations. ⋅Minimum structural content: An output state at termination that satisfies the defined termination condition. ⋅Excluded cases: Partial intermediate outputs and states requiring additional claimed transformation steps.

### State-Transition Trace Record

Positive definition: A machine-processable record generated for one or more iterations of the disclosed process that identifies information associated with a state transition of the information structure. ⋅Negative boundary: Not an unaudited log, arbitrary explanation, or narrative rationale disconnected from the detected inconsistency, candidate transformations, inconsistency measure, permitted subset, selected transformation, updated structure, or termination status. ⋅Minimum structural content: At least one identifier of a current information structure, detected inconsistency, inconsistency measure, selected candidate transformation, updated information structure, or termination status. ⋅Excluded cases: Generic activity logs, free-form commentary, unverifiable explanations, and records not associated with the disclosed inconsistency-resolution process.

### Transformation-Order Divergence Reduction

Positive definition: A property in which deterministic or globally consistent selection rules reduce divergence caused by arbitrary transformation ordering under stated process conditions. ⋅Negative boundary: Not a guarantee that all possible transformation orders produce an identical final structure or that every possible transformation sequence reaches the same result. ⋅Minimum structural content: A permitted subset of candidate transformations, a deterministic selection rule, global evaluation metric, or predefined tie-breaking procedure, and defined process conditions under which arbitrary ordering alone does not determine the selected transformation. ⋅Excluded cases: Arbitrary ordering outside the stated process conditions, universal convergence for all transformation sequences, and implementations requiring any particular undisclosed internal scoring, ordering, selection, or optimization procedure.

### Computing Environment and Processor-Executed Decision-State Implementations

The present systems and methods for resolving inconsistency within an information structure may be implemented in any processor-implemented, computer-implemented, or software-controlled environment in which one or more computing systems, processors, processing circuits, or processor-executable components store, access, evaluate, modify, enforce, output, or transmit a machine-processable information structure. Such information structures may include decision-state, policy-state, rule-state, permission-state, authorization-state, classification-state, workflow-state, configuration-state, compliance-state, mission-state, control-state, navigation-state, safety-state, reasoning-state, action-state, account-state, transaction-state, device-state, or other machine-processable state information.

The disclosed systems and methods may be implemented using one or more computing devices, processors, processing circuits, servers, local computing systems, distributed computing systems, cloud computing systems, edge computing systems, containerized runtimes, application services, mobile devices, embedded devices, enterprise systems, financial systems, regulatory systems, security systems, defense systems, autonomous systems, robotic systems, aviation systems, vehicle-control systems, artificial-intelligence systems, policy-enforcement systems, workflow systems, or other processor-executable environments. The implementation environment is non-limiting and may be local, remote, distributed, networked, non-networked, or any combination thereof.

The disclosed process is not limited to any particular hardware architecture or to a hardware-specific improvement. Rather, in some implementations, the disclosed process may improve processor-implemented or computer-implemented processing of machine-processable information structures by constraining candidate transformations to a permitted subset determined with respect to an inconsistency measure and defined process conditions, thereby reducing application of non-permitted transformations, reducing redundant or ineffective transformation attempts, limiting propagation of unresolved inconsistency through downstream processing, and enabling termination when no further permitted candidate transformation that reduces the inconsistency measure remains available. In some implementations, use of the permitted subset, candidate-test data, post-transformation inconsistency measures, reduction values, and state-transition trace records may reduce processing time, memory use, repeated evaluation, re-computation, storage of unnecessary intermediate states, or downstream validation burden relative to an unconstrained inconsistency-removal or arbitrary rewrite process.

A computing device or system may include one or more processors, memories, non-transitory computer-readable storage media, input interfaces, output interfaces, communication interfaces, buses, operating-system components, runtime components, databases, data stores, software modules, application programming interfaces, local files, distributed storage, graph stores, rule stores, constraint stores, document stores, object stores, key-value stores, event streams, message queues, or other hardware or software components suitable for executing processor-readable instructions and processing machine-processable information structures.

Processor-executable instructions may be stored on one or more non-transitory computer-readable media and executed by one or more processors. During execution, the processor may operate on machine-processable data structures stored in memory, storage, a database, a graph store, a rule store, a constraint store, a document store, a local file, an application runtime, a server runtime, a distributed runtime, a cloud runtime, an artificial-intelligence wrapper, or another machine-accessible data environment.

In some implementations, elements of the information structure may correspond to decision options, policy rules, regulatory requirements, safety constraints, mission constraints, command constraints, authorization states, sensor reports, perception records, navigation states, route options, control actions, user instructions, system constraints, permissions, prohibitions, approval states, denial states, eligibility states, classification states, workflow steps, action candidates, model-generated propositions, tool outputs, retrieved facts, configuration records, account records, transaction records, security rules, device states, or other machine-processable items. Relationships may correspond to allows, denies, requires, prohibits, applies-to, depends-on, supports, contradicts, overrides, conflicts-with, substitutes-for, routes-to, authorizes, blocks, escalates, requires-review, or otherwise relates-to relationships among those elements.

Incompatibility conditions may be defined over such elements and relationships. For example, an incompatibility condition may be violated when a software rule both permits and prohibits the same action under the same context, when a security protocol state permits access while an authorization rule denies access, when a required authentication factor is absent from an active session state, when an encryption requirement conflicts with an unencrypted transfer action, when a firewall rule allows traffic that a segmentation policy prohibits, when a workflow state authorizes an action that an applicable policy blocks, when a public-sector eligibility rule conflicts with a statutory exclusion condition, when a private-sector compliance rule conflicts with an operational approval state, when a financial transaction is simultaneously approved and held for review, when an account is simultaneously marked active and closed, when a mobile-device policy permits an application action while a privacy rule prohibits it, when an autonomous vehicle candidate action conflicts with a traffic rule or safety constraint, when a drone route conflicts with a geofence or return-condition rule, when an autopilot mode conflicts with a navigation constraint or safety-envelope constraint, when a robotic motion plan conflicts with a collision-avoidance constraint, when a defense-system action state conflicts with an authorization, mission, identification, or policy constraint, or when an artificial-intelligence system proposes an external action while a local-only constraint is active.

Candidate transformations may include modifying an element, substituting an element, deactivating an element, removing or relabeling a relationship, marking an action or record as non-permitted, quarantining a record for review, substituting a compatible action, deferring an operation, requiring approval, escalating to review, reassigning a resource, selecting a compatible dependency, blocking an action, routing to an alternative workflow, selecting a safer or policy-compliant control option, modifying a route, changing an authorization state, changing a permission state, changing a classification state, changing an approval state, changing a device-state record, changing a configuration state, changing a workflow state, changing an account-status record, changing a transaction-state record, or applying another machine-processable modification associated with a detected inconsistency type and affected locus.

The processor may evaluate candidate transformations using test representations of the information structure, calculate post-transformation inconsistency measures, determine a permitted subset under defined process conditions, select a candidate transformation from the permitted subset that reduces the inconsistency measure, apply the selected transformation to update the information structure, and generate a state-transition trace record identifying one or more detected inconsistencies, affected loci, candidate-test data, post-transformation inconsistency measures, reduction values, permitted-subset data, selected-transformation data, updated-structure data, termination-status data, resulting-structure data, or other trace data associated with the disclosed process.

In a regulatory-policy implementation, the information structure may include statutes, regulations, agency rules, eligibility rules, exclusion criteria, approval conditions, review requirements, enforcement constraints, applicant records, transaction records, case records, workflow records, or decision options. An inconsistency may be detected when two or more active rules, requirements, or decision states cannot simultaneously be satisfied under the applicable defined incompatibility condition. The disclosed process may determine a permitted subset of candidate transformations, such as requiring review, marking an action non-permitted, substituting a compliant workflow, deactivating an inconsistent decision option, routing the matter to an exception process, or updating a decision-state record.

In a private-sector policy implementation, the information structure may include internal policies, compliance rules, approval workflows, risk controls, security rules, user permissions, resource assignments, transaction rules, audit requirements, operational states, workflow states, exception states, or enforcement states. An inconsistency may be detected when an operational state permits an action that a policy prohibits, when two approval states conflict, when a required control is absent, when an exception state conflicts with an enforcement state, or when a rule permits and denies the same action for the same subject, resource, or context.

In a financial-system implementation, the information structure may include account records, transaction records, customer-identity records, account-status values, approval states, denial states, fraud-hold records, payment instructions, payment-routing states, compliance rules, audit-control rules, risk rules, authorization records, entitlement records, or exception records. An incompatibility condition may be violated when an account is simultaneously marked active and closed, when a transaction is both approved and blocked under applicable rules, when a scheduled payment conflicts with an account-freeze condition, when a payment route conflicts with a required routing policy, when a fraud-hold state conflicts with a release state, or when an employee entitlement violates a separation-of-duty condition.

In a security or access-control implementation, the information structure may include users, roles, permissions, resources, allow rules, deny rules, device-compliance states, firewall rules, encryption requirements, data-loss-prevention labels, access requests, security alerts, governance policies, authentication states, authorization states, or trust states. An inconsistency may be detected when a user has both allow and deny permissions for the same resource, when a device is marked trusted while failing a compliance rule, when a file is permitted for external sharing while labeled confidential, when a transfer action is active while an applicable encryption rule is unsatisfied, when a firewall rule allows and blocks the same traffic under the same context, or when an authentication state conflicts with an authorization requirement.

In a cybersecurity or security-protocol implementation, the information structure may include authentication-state records, authorization-state records, credential records, session-state records, encryption-policy records, key-management records, certificate-state records, trust-state records, firewall-rule records, network-segmentation records, access-control records, identity-provider records, device-compliance records, data-loss-prevention records, audit-control records, incident-response records, or protocol-state records. Relationships may include authenticates, authorizes, denies, permits, requires-encryption, requires-review, trusts, depends-on, applies-to, conflicts-with, overrides, supports, blocks, or substitutes-for relationships. An incompatibility condition may be violated when a protocol state permits access while an authorization rule denies access, when a session is marked trusted while a required authentication factor is absent, when a certificate or key state conflicts with an encryption requirement, when a firewall rule permits traffic that a segmentation policy prohibits, when a data-transfer action is active while a data-loss-prevention rule prohibits disclosure, when a device is marked compliant while a required security control is absent, or when a protocol transition would move from one state to another state that violates a defined security constraint. Candidate transformations may include blocking an action, marking an action non-permitted, requiring additional authentication, substituting an encrypted transfer, deactivating a conflicting rule, quarantining a session or device state, routing to review, updating a trust state, or generating a trace record identifying the detected security inconsistency, tested candidate transformations, permitted subset, selected transformation, updated structure, and termination status.

In a mobile-device implementation, the information structure may include application-permission records, privacy-policy records, security-policy records, mobile-device-management profile records, network-profile records, app-update records, package-dependency records, notification-rule records, sensor-access records, local-file-access records, user-instruction records, tool-output records, model-output records, candidate-action records, or local reasoning-state records. An inconsistency may be detected when an app requests a sensor permission prohibited by an applicable policy, when a Wi-Fi-only rule conflicts with a proposed cellular upload, when an app update requires an incompatible package dependency, when a notification rule conflicts with a do-not-disturb constraint, or when a local-only instruction conflicts with a proposed external cloud operation.

In a safety-critical autonomous-system implementation, the information structure may include mission constraints, safety constraints, route options, navigation states, sensor records, perception outputs, control modes, candidate maneuvers, geofence records, authorization states, return-condition rules, collision-avoidance rules, command constraints, vehicle-state records, aircraft-state records, robotic-workspace records, or control-action records. An inconsistency may be detected when a candidate route, maneuver, mode, or action cannot simultaneously satisfy applicable safety, authorization, navigation, mission, policy, geofence, collision-avoidance, or control constraints. Candidate transformations may include modifying a route, selecting a compatible maneuver, deferring an action, marking an action non-permitted, requiring review or authorization, substituting a safer action, routing to an alternative control state, or generating an updated control-state structure.

In a defense or mission-system implementation, the information structure may include mission-state records, authorization-state records, sensor-report records, classification-state records, command-constraint records, no-action-zone records, rules-of-engagement records, policy-constraint records, route records, platform-state records, communication-state records, or candidate-action records. An inconsistency may be detected when a proposed action, route, classification, authorization state, or command state conflicts with an applicable authorization, identification, mission, safety, communication, no-action-zone, or policy constraint. Candidate transformations may include marking an action non-permitted, requiring additional review or authorization, substituting a compliant action, modifying a route, deactivating an inconsistent candidate action, preserving a higher-priority constraint, or updating the mission-state information structure. This example is non-limiting and does not require any particular weapon system, targeting procedure, tactical procedure, or operational doctrine.

In an artificial-intelligence or software-agent implementation, the information structure may include user instructions, system constraints, model outputs, tool outputs, retrieved facts, memory facts, candidate actions, planned operations, policy rules, permission states, reasoning-state records, or local runtime records. An inconsistency may be detected when a proposed action conflicts with a user instruction, tool output, permission condition, policy rule, system constraint, retrieved fact, or memory fact. Candidate transformations may include modifying the action, substituting a compatible action, deactivating a conflicting proposition, marking an action non-permitted, requiring additional evidence, deferring an action, or generating an updated reasoning-state structure.

In a healthcare, insurance, education, logistics, procurement, infrastructure, or public-benefit implementation, the information structure may include eligibility records, benefit records, claim records, coverage rules, care-pathway rules, scheduling records, routing records, procurement rules, inventory records, service-level requirements, safety rules, approval states, denial states, exception states, or workflow states. An inconsistency may be detected when an eligibility rule conflicts with an exclusion condition, when a claim is both approved and denied under applicable rules, when a logistics route conflicts with a delivery constraint, when a procurement approval conflicts with a policy restriction, or when a workflow step is authorized while a required prerequisite remains unsatisfied.

Input to the computing system may include text, structured records, semi-structured records, graph data, policy data, configuration data, proposition data, access-control data, entitlement data, deployment-state data, compliance-rule data, financial data, transaction data, regulatory data, public-sector records, security data, mobile-device state data, sensor data, vehicle-state data, mission-state data, model output, tool output, retrieved facts, memory entries, candidate actions, planned operations, local file metadata, application state, runtime state, or other machine-processable or machine-convertible data.

Output from the computing system may include a resulting information structure, updated element records, updated relationship records, modified configuration data, repaired graph data, updated policy data, updated access-control data, updated financial-state data, updated transaction-state data, updated regulatory-decision data, updated mobile-device-state data, updated control-state data, updated reasoning-state data, a state-transition trace record, candidate-test data, permitted-subset data, selected-transformation data, termination-status data, a stored file, a database update, a displayed result, an application programming interface response, or data supplied to a downstream software module.

The foregoing examples are non-limiting. They illustrate that the disclosed process may be used wherever processor-implemented, computer-implemented, or software-controlled logic maintains a machine-processable information structure and must make or support a decision, action, classification, permission, approval, denial, routing, enforcement operation, control operation, workflow operation, reasoning operation, or output under defined constraints. The invention is not limited to any particular public-sector system, private-sector system, regulated industry, financial system, security system, defense system, autonomous system, vehicle system, robotic system, aviation system, mobile system, artificial-intelligence system, database, programming language, runtime environment, hardware device, network architecture, or application domain unless expressly recited in a claim.

The present systems and methods for resolving inconsistency within an information structure may be implemented in a network environment comprised of individual computing devices (also “mobile devices”). As used herein and throughout this disclosure, the term “mobile device” or “computing device” may refer to any electronic device capable of communicating across a mobile network. A mobile device may have a processor, a memory, a transceiver, an input, and an output. Examples of such computing devices include cellular telephones, personal digital assistants (PDAs), portable computers, etc. The memory of a computing device may store applications, software, processor-executable instructions or logic. Examples of processors may include computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories). A transceiver may include but is not limited to cellular, GPRS, Bluetooth, and Wi-Fi transceivers.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH.® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database. For instance, an authentication server may host or may be in communication with a database having authentication information for users of a mobile network. A “user account” may include several attributes for a particular user, including a unique identifier of the mobile device(s) owned by the user, relationships with other users, call data records, bank account information, etc.

A computing device input may refer to the various mechanisms on a device through which a user may provide data to a computing device. Exemplary computing device input may include, but are not limited to a screen, a touchscreen, a keyboard, buttons, a microphone or a camera. Similarly, a computing device output may refer to the various mechanisms on a computing device through which data may be displayed, vocalized or otherwise presented to a user. Exemplary computing device output may include, but are not limited to, a screen, a touchscreen or a speaker.

### DETAILED DESCRIPTION OF THE INVENTION

For the following description, it can be assumed that most correspondingly labeled elements across the figures (e.g., 105 and 205, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

The present invention relates to processor-implemented or computer-implemented methods and systems for resolving inconsistency within an information structure. In general, the disclosed invention operates over a structured information domain comprising elements and relationships among those elements, detects one or more inconsistencies under a defined incompatibility condition, evaluates candidate transformations that may modify the information structure, determines under defined process conditions a permitted subset of candidate transformations, and iteratively applies a selected candidate transformation from the permitted subset that reduces the inconsistency measure until a resulting structure at termination is produced.

The disclosed invention operates as a closed, internally coupled state-transition process over an evolving information structure. Within that process, inconsistency detection, determination of the permitted subset, transformation selection, structural modification, iteration, and termination are linked through the same information structure and the same inconsistency measure, such that permitted state transitions are constrained under the defined process conditions and the process terminates when no further permitted candidate transformation that reduces the inconsistency measure remains available under the defined process conditions.

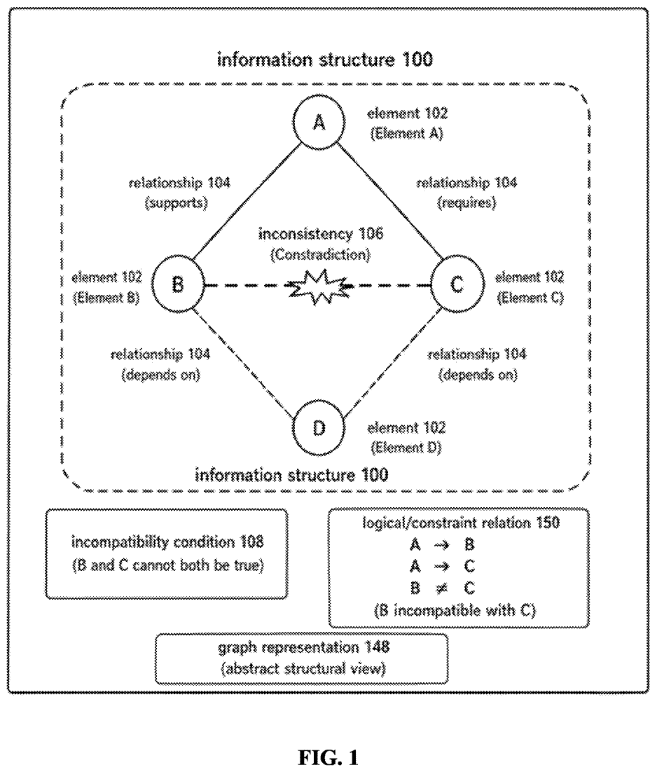

FIG. 1-6 illustrate representative views of the disclosed inconsistency-resolution architecture, including example structure representation, process flow, structural transformation, iterative evolution, inconsistency-measure progression, and state-transition trace-record generation.

At a system level, the disclosed invention may be understood as including functional operations for: (i) representing or storing an information structure; (ii) identifying relationships among elements of that structure; (iii) detecting inconsistency under a defined incompatibility condition; (iv) generating or identifying candidate transformations capable of modifying the structure; (v) determining, under defined process conditions, a subset of candidate transformations permitted for application to the information structure; (vi) selecting from the permitted subset and applying a candidate transformation that reduces the inconsistency measure of the information structure under the defined process conditions; (vii) updating the information structure after transformation; (viii) determining whether a termination condition has been satisfied; and (ix) in some embodiments, generating a state-transition trace record identifying one or more detected inconsistencies, inconsistency measures before and after candidate transformation testing, candidate transformations, the permitted subset, the selected transformation, the updated information structure, and a termination status. In the disclosed invention, the permitted subset is determined with respect to the inconsistency measure of the information structure and the defined process conditions, so that permitted candidate transformations are distinguished from non-permitted candidate transformations.

In some embodiments, the disclosed functional operations may further include converting received input into a machine-processable information structure before inconsistency detection is performed, determining whether the machine-processable information structure satisfies a predefined condition indicating that inconsistency-resolution processing should be performed under the defined process conditions, generating or storing a state-transition trace record associated with one or more iterations of the process, and storing the resulting information structure in memory before output.

The disclosed invention therefore does not operate as an arbitrary rewrite engine or unconstrained cleanup loop. Rather, it operates as a constrained inconsistency-resolution process in which modifications to the information structure occur through candidate transformations permitted under the defined process conditions and evaluated relative to the inconsistency state of the structure. Under the disclosed embodiment, the permitted subset comprises candidate transformations distinguished from non-permitted candidate transformations under the defined process conditions. In some embodiments, determination of the permitted subset may include non-increase of detected inconsistencies together with monotonic descent conditions evaluated with respect to the inconsistency measure. The claimed iterative process, however, evolves the information structure through application of a selected permitted candidate transformation that reduces the inconsistency measure toward a termination state in which no further such permitted candidate transformation remains available.

The invention may be embodied in a variety of implementation forms, including rule-based systems, graph-processing systems, logical or constraint-based systems, or other computational frameworks capable of representing an information structure and carrying out the disclosed process. Although particular embodiments may describe specific representation forms, transformation classes, or selection mechanisms, the invention is not limited to any single implementation framework unless expressly stated. The central architecture which remains consistent across the various embodiments is the use of a structured information domain, inconsistency detection under a defined incompatibility condition, determination under defined process conditions of a permitted subset of candidate transformations with respect to an inconsistency measure, iterative modification of the information structure through selection and application of a permitted candidate transformation that reduces the inconsistency measure, and termination under defined process conditions.

The following description sets forth various embodiments of the disclosed methods and systems and illustrates representative ways in which the foregoing system-level process may be implemented.

### Structural Treatment of Information

In the disclosed embodiments, information is treated as having machine-observable structure. The disclosed process does not operate merely on information such as unstructured text, narrative meaning, or isolated data values. Rather, received information is represented, converted, or maintained as a machine-processable information structure comprising identifiable elements, relationships, attributes, constraints, states, actions, or other structural components.

Under this structural treatment, an item of information may be evaluated according to the components that make up the information and the relationships among those components. A statement, rule, model output, proposed action, configuration state, policy state, graph fragment, record set, or reasoning-state output may be decomposed or represented as elements and relationships within an information structure. The resulting structure may then be evaluated under one or more incompatibility conditions to determine whether structural components cannot simultaneously be satisfied, maintained, selected, executed, or treated as active under defined process conditions.

The disclosed process therefore resolves inconsistency by examining structural components of information and by applying candidate transformations to the information structure. A candidate transformation may modify, substitute, deactivate, remove, relabel, quarantine, merge, split, block, revise, or otherwise change one or more elements, relationships, attributes, states, actions, or substructures of the information structure.

This structural treatment of information allows the process disclosed herein to operate across various computational domains because the particular source of the information may vary while the process remains directed to structural components: identifying elements and relationships, detecting incompatibility among structural components, testing candidate transformations, applying a selected permitted transformation, updating the information structure, and terminating under defined process conditions.

### DETAILED DESCRIPTION OF ENABLED EMBODIMENT

### 1. Representation

In one embodiment, an information structure is represented as a set or graph of elements, where each element corresponds to a proposition, constraint, or state descriptor.

Relationships among elements may be represented explicitly (e.g., edges in a graph) or implicitly (e.g., logical or constraint relationships).

FIG. 1 depicts an example information structure 100. As depicted, the information structure 100 includes elements 102 and relationships 104 arranged in a graph representation 148.

In one example nodes such as “A”, “NOT A” and “B” may be connected via edges defining logical relationships or constraints.

In some embodiments, received input data may be converted into the machine-processable information structure before inconsistency detection is performed. Such conversion may include organizing received elements, constraints, state descriptors, or relationships into a representation suitable for evaluation under the defined incompatibility condition. The specific conversion procedure may vary, provided that the resulting structure remains a machine-processable information structure comprising elements and relationships suitable for inconsistency-resolution processing.

### 2. Inconsistency Detection

An inconsistency is defined as a condition in which two or more elements of the information structure cannot simultaneously be satisfied under a defined incompatibility condition.

As depicted in FIG. 1, an inconsistency 106 may arise under an incompatibility condition 108 defined over elements 102 within the information structure 100. As depicted, the inconsistency 106 is shown between elements B and C under the stated incompatibility condition 108. The illustrated element labels are not intended to define a required contradiction pair. The incompatibility shown between B and C in FIG. 1 is a non-limiting example only. In other embodiments, an inconsistency may be represented by a logical contradiction such as “A” and “NOT A”, or by another defined incompatibility condition applicable to elements of the information structure.

Example: “A” and “NOT A” constitute an inconsistency.

Detection may be performed by: ⋅evaluating element pairs, or ⋅evaluating constraint violations across the structure.

The result of detection is a set of identified inconsistencies.

In some embodiments, before inconsistency-resolution processing proceeds, the processor may determine whether the machine-processable information structure satisfies a predefined condition indicating that further inconsistency-resolution processing should be performed under the defined process conditions. Such a predefined condition may correspond, for example, to the presence of at least one detected inconsistency, structural incompleteness, or another defined condition indicating that transformation-based modification of the information structure is required.

### 3. Transformation Set

A plurality of candidate transformations is defined, each capable of modifying the information structure.

In one embodiment, transformations include: ⋅removal of an element ⋅modification of an element ⋅substitution of an element.

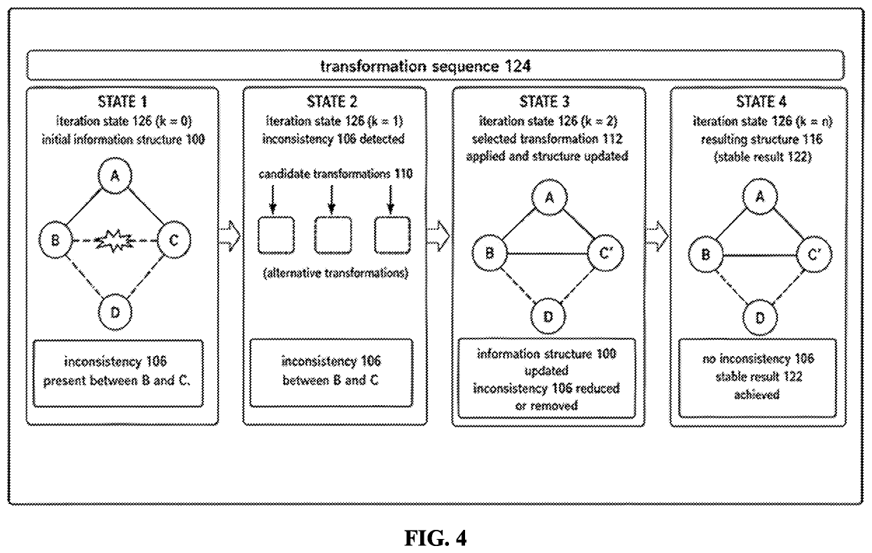

Candidate transformations 110 may be generated in response to a detected inconsistency 106, as illustrated in the iterative evolution shown in FIG. 4.

### Example

If A and NOT A are both present, a transformation may remove or modify one of the elements.

### 4. Permitted-Subset Criterion (Non-Limiting Embodiment)

A transformation is permitted for the embodiment if it satisfies the following conditions: ⋅it does not increase the number of detected inconsistencies, and ⋅it satisfies a monotonic descent condition with respect to a defined inconsistency measure.

The inconsistency measure: ⋅is a bounded function defined over the information structure, and ⋅is reduced by at least one permitted inconsistency-reducing transformation in any non-stable state.

Evaluation may be performed by: ⋅computing the inconsistency measure before transformation ⋅computing the inconsistency measure after transformation ⋅identifying candidate transformations that satisfy the admissibility criterion, and, in claimed reduction-based embodiments, selecting a transformation that reduces the measure.

In this embodiment, the admissibility criterion is not a discretionary preference or heuristic ranking alone. Rather, it governs whether a candidate transformation is permitted to modify the information structure within the claimed process. A candidate transformation is therefore not applied merely because it alters the structure or because it appears locally favorable, but because it satisfies the defined admissibility conditions relative to the detected inconsistency state and the defined inconsistency measure. In this way, admissibility constrains the set of permissible state transitions available to the process at any iteration.

The inconsistency measure is used not only to observe whether inconsistency is present, but to evaluate whether a proposed transition is permitted under the process conditions. Candidate transformations are evaluated against the inconsistency measure before and after application, and only those transformations satisfying the admissibility criterion are eligible for selection. Under the disclosed embodiment, this creates a bounded transformation space comprising the candidate transformations that are permitted under the defined process conditions, such that permitted transitions are distinguished from non-permitted transitions by reference to the measured inconsistency state of the information structure.

For example, in a constraint-based implementation, a candidate transformation may be permitted where application of that transformation reduces or does not increase mutually unsatisfiable constraint conditions within the information structure under the defined process conditions.

In some embodiments, the inconsistency measure may also be applied to evaluate the effect of system-selected transitions on the evolving information structure over successive iterations. Under such embodiments, candidate transitions that increase structural conflict within the information structure may be disfavored or excluded, while transitions associated with downward-trending inconsistency may be preferred. In this way, the disclosed process may constrain system-selected transitions toward progressively reduced structural conflict under the defined process conditions.

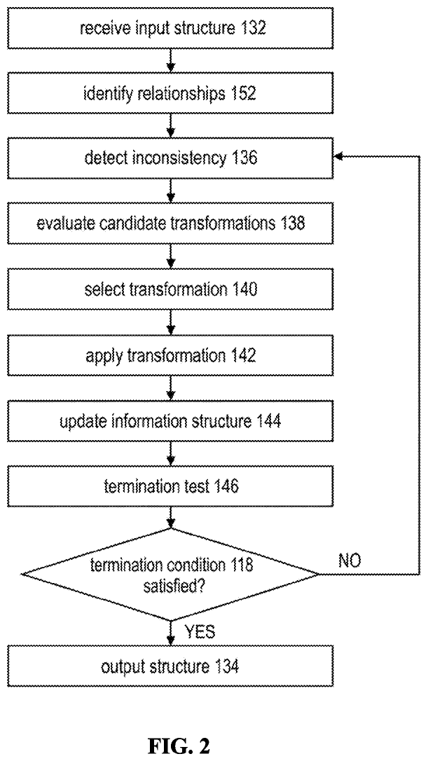

In the illustrated process flow of FIG. 2, detected inconsistency 136 leads to evaluation of candidate transformations 138, followed by selection of a transformation 140 and application of that transformation 142. In such embodiments, admissibility is determined with respect to the inconsistency measure before a candidate transition is permitted to modify the information structure.

### 5. Transformation Selection

In some embodiments, selection from the permitted subset may be performed using a deterministic selection rule, global evaluation metric, or predefined tie-breaking procedure. Such selection may reduce divergence caused by arbitrary transformation ordering by preventing arbitrary ordering alone from determining which permitted candidate transformation is applied from a given information structure and permitted subset under the defined process conditions.

In one non-limiting example, the processor may select a permitted candidate transformation based on a post-transformation inconsistency measure. Where two or more permitted candidate transformations produce the same post-transformation inconsistency measure, the processor may apply a predefined tie-breaking procedure, such as a fixed ordering of candidate transformation classes, candidate identifiers, or another application-facing ordering rule.

This selection embodiment is non-limiting and application-facing. It does not require universal convergence of all possible transformation sequences, does not require all possible transformation orders to produce an identical final structure, and does not require any particular internal scoring, ordering, selection, or optimization procedure beyond the disclosed process conditions.

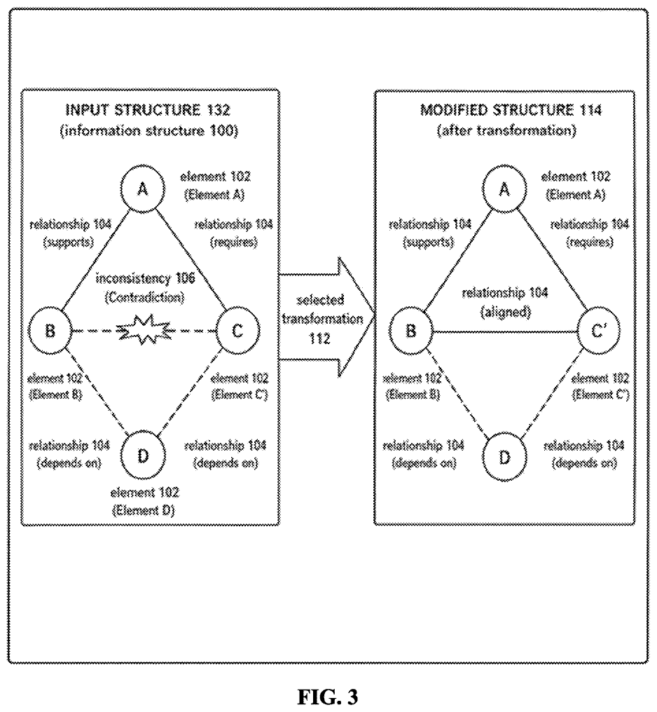

FIG. 3 illustrates an example in which a selected transformation 112 is applied to an input structure 132 to produce a modified structure 114. FIG. 3 thus illustrates an example intermediate transformation step within the disclosed iterative process.

### 6. Iterative Process

The system performs the following:

In some embodiments, the iterative process begins only after the processor determines that the machine-processable information structure satisfies a predefined condition indicating that inconsistency-resolution processing should be performed under the defined process conditions.

WHILE permitted candidate transformations that reduce the inconsistency measure remain available under the defined process conditions:
1. Detect inconsistencies
2. Evaluate candidate transformations
3. Select, from the permitted subset, a candidate transformation that reduces the inconsistency measure under the defined process conditions
4. Apply transformation to modify the structure
5. Update the information structure

Each iteration therefore proceeds through a constrained transition step in which only candidate transformations in the permitted subset are eligible to move the information structure from its current inconsistency state to a subsequent state.

FIG. 4 illustrates an example transformation sequence 124 across iteration states 126. In the illustrated sequence, a detected inconsistency 106 gives rise to candidate transformations 110, a selected transformation 112 is applied, the information structure 100 is updated, and a resulting structure 116 is produced.

### 7. Termination

The process terminates when: ⋅no further permitted candidate transformations that reduce the inconsistency measure remain available under the defined process conditions.

Under disclosed conditions in which the inconsistency measure is bounded over a finite or discrete state space and permitted candidate transformations that reduce the inconsistency measure under the defined process conditions enforce monotonic descent, the process terminates in a finite number of iterations.

Under the disclosed embodiment, termination corresponds to exhaustion of the bounded transformation space for the current information structure with respect to permitted candidate transformations that reduce the inconsistency measure under the defined process conditions. The process therefore terminates not because of arbitrary stopping or external interruption, but because no further permitted candidate transformations that reduce the inconsistency measure remain available under the defined process conditions.

In disclosed embodiments, the set of permitted candidate transformations that reduce the inconsistency measure available for a current information structure at a given iteration is finite under the defined process conditions.

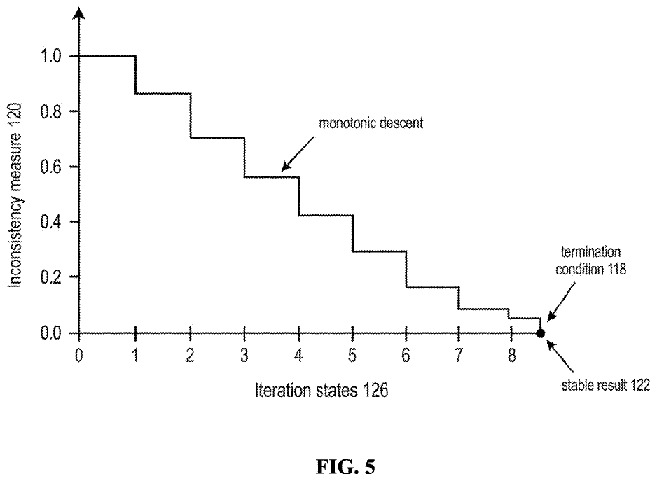

FIG. 5 illustrates example progression of the inconsistency measure toward termination under disclosed conditions. As shown in FIG. 5, an inconsistency measure 120 may decrease across iteration states 126 until the termination condition 118 is met and a stable result 122 is achieved.

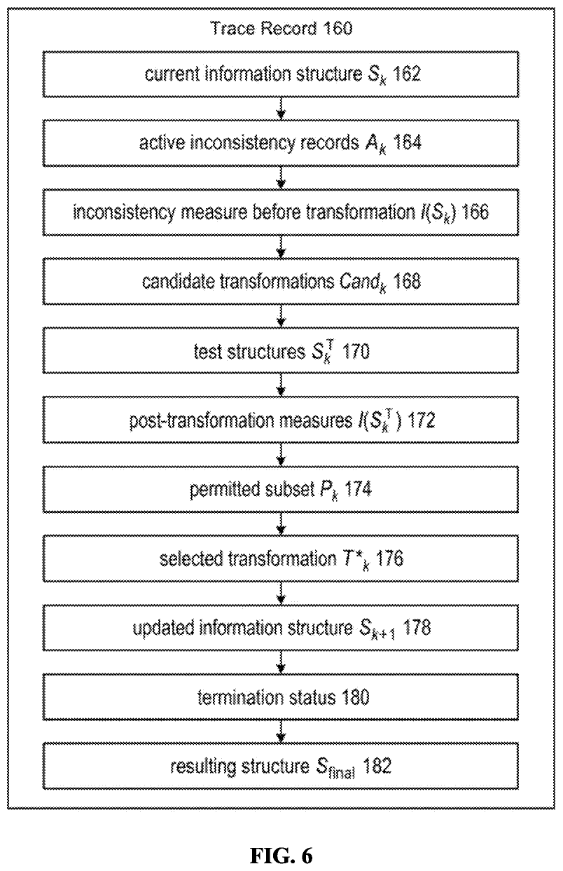

FIG. 6 illustrates an example state-transition trace record 160. The trace record 160 may include a current information structure 162, one or more detected inconsistency records 164, an inconsistency measure before transformation 166, candidate-transformation test data 168, one or more test information structures 170, post-transformation inconsistency measures 172, a permitted subset 174, a selected candidate transformation 176, an updated information structure 178, a termination status 180, and a resulting structure 182. The trace record 160 is application-facing and non-limiting and may be implemented using any suitable machine-processable record, data structure, storage format, or software procedure.

In some embodiments, once the termination condition is satisfied, the resulting information structure may be stored in memory before output. The processor may thereafter output the resulting information structure after determining that the disclosed process conditions for termination have been satisfied.

For example, where an information structure contains multiple permitted candidate transformations that reduce the inconsistency measure and are applicable to the same detected inconsistency state, deterministic or globally consistent selection may reduce divergence caused by arbitrary transformation ordering by preventing arbitrary ordering alone from determining which permitted candidate transformation is selected under the defined process conditions.

### 8. Transformation-Order Divergence Reduction

In some embodiments, deterministic or globally consistent selection rules may reduce divergence caused by arbitrary transformation ordering. Such reduction may occur where candidate transformations are evaluated under the same defined process conditions and with respect to the same inconsistency measure.

For example, where an information structure contains multiple permitted candidate transformations applicable to a detected inconsistency state, a deterministic selection rule, global evaluation metric, or predefined tie-breaking procedure may be used so that arbitrary ordering alone does not determine which permitted candidate transformation is selected.

Transformation-order convergence is not claimed universally and is not required for all embodiments. The disclosed selection mechanisms do not require every possible transformation sequence to reach the same result and do not require all possible transformation orders to produce an identical final structure.

### 9. Generalization

The method applies to logical systems, constraint systems, graph-based representations by defining: inconsistency conditions, a permitted subset of candidate transformations under the defined process conditions, bounded inconsistency measures and selection rules.

### 10. Implementation

The method may be implemented using: rule-based systems, graph-processing algorithms and/or constraint solvers.

As used herein, computer-implemented, processor-implemented, and machine-implemented processing may include processing performed by one or more processors, microprocessors, microcontrollers, processing circuits, programmable logic devices, hardware logic, special-purpose computing hardware, distributed processing resources, firmware, software, or combinations thereof. Such processing is not limited to a desktop computer, laptop computer, server computer, or general-purpose personal computer.

In system embodiments, memory may store both the machine-processable information structure undergoing modification and the resulting information structure after the termination condition is satisfied.

In some implementations, the inconsistency measure may be used to evaluate the effect of system-selected transitions over successive iterations, including by disfavoring or excluding transitions associated with increasing values of the inconsistency measure and preferring transitions associated with decreasing values of the inconsistency measure under the defined process conditions.

### 11. Example Technical Implementations

In some implementations, the disclosed process operates over a graph-based information structure representing entities and dependency relationships. In such implementations, inconsistencies may correspond to incompatible dependency states, incompatible assignment states, contradictory relationship states, or other graph conditions that cannot simultaneously be satisfied under the defined incompatibility condition. Candidate transformations in the permitted subset may modify one or more nodes, edges, or associated state descriptors subject to the inconsistency measure and termination condition.

Examples of such graph-based implementations may include enterprise knowledge graphs, identity graphs, access relationship graphs, topology graphs, digital twin graphs, asset relationship graphs, dependency graphs, supply-chain graphs, master-data graphs, and entity-resolution back-end graphs. In such implementations, the resulting structure may be stored, supplied to downstream graph processing, used for continued computational analysis, or used to govern subsequent machine operations.

In some implementations, the disclosed process operates over a configuration or constraint structure representing machine configuration states, policy rules, or resource assignments. In such implementations, inconsistencies may correspond to mutually unsatisfiable constraints, incompatible policy states, conflicting dependency conditions, invalid assignments, or contradictory configuration relations. Candidate transformations in the permitted subset may modify one or more configuration elements, assignments, dependencies, policy relations, or associated state descriptors to produce a resulting structure suitable for deployment, validation, enforcement, downstream computation, or continued machine control.

Examples of such configuration or constraint implementations may include cloud deployment state, infrastructure-as-code state, orchestration state, machine configuration state, access-control assignments, entitlement state, policy administration state, scheduling state, resource-allocation state, network-policy state, security-policy state, and distributed-system reconciliation state.

In some implementations, the disclosed process operates over a software-analysis or verification structure representing program facts, rule relations, or verification conditions. In such implementations, inconsistencies may correspond to incompatible structural conditions, contradictory rule effects, incompatible inferred states, unsatisfied verification conditions, or other analysis states that cannot simultaneously be satisfied under the defined incompatibility condition. Candidate transformations in the permitted subset may iteratively modify one or more represented facts, rule relations, dependency relations, or verification conditions until no further permitted candidate transformation that reduces the inconsistency measure remains available under the defined process conditions.

Examples of such software-analysis or verification implementations may include static-analysis state, formal-verification state, rule-consistency structures, verification artifact sets, program dependency structures, program fact structures, security-analysis structures, compliance-checking structures, and rule-evaluation state maintained for automated software or system analysis. In such implementations, the resulting structure may be used for continued verification, downstream software analysis, rule enforcement, compliance evaluation, or other machine-executed processing.

In some implementations, the disclosed process may be applied in identity and access management environments in which the information structure comprises users, roles, groups, permissions, resources, and policy relations maintained in machine-processable form. In such implementations, inconsistencies may correspond to incompatible entitlements, mutually exclusive role assignments, separation-of-duty violations, contradictory access states, or other unsatisfiable policy-governed assignments. Candidate transformations in the permitted subset that reduce the inconsistency measure may modify role relations, permission assignments, group membership, policy relations, or associated structural elements under the defined process conditions.

In some implementations, the disclosed process may be applied in cloud, orchestration, and infrastructure management environments in which the information structure comprises configuration objects, service dependencies, policy constraints, version relations, deployment conditions, or resource assignments. In such implementations, inconsistencies may correspond to mutually unsatisfiable deployment states, conflicting dependency conditions, invalid resource assignments, incompatible policy states, or contradictory configuration relations. Candidate transformations in the permitted subset that reduce the inconsistency measure may modify one or more configuration objects, assignments, dependencies, policy relations, or state descriptors to produce a resulting structure suitable for deployment, validation, or continued machine control.

In some implementations, the disclosed process may be applied in enterprise data integration, master data management, and entity resolution environments in which the information structure comprises records, entities, attributes, and inter-entity relationships combined from multiple machine-readable sources. In such implementations, inconsistencies may correspond to incompatible state descriptors, contradictory entity attributes, or incompatible inter-record relationships within the resulting structured representation. Candidate transformations in the permitted subset that reduce the inconsistency measure may modify elements or relationships within the integrated structure to produce a resulting structure suitable for storage, downstream analytics, graph processing, or continued computational use.

In some implementations, the disclosed process may be applied in digital twin, topology management, or asset-state environments in which the information structure comprises modeled assets, components, connections, dependencies, operating states, or control relations represented in machine-processable form. In such implementations, inconsistencies may correspond to incompatible topology conditions, contradictory state descriptors, invalid dependency conditions, or mutually unsatisfiable operational relations. Candidate transformations in the permitted subset that reduce the inconsistency measure may modify the modeled structure to produce a resulting structure suitable for simulation, monitoring, control, validation, or downstream computational use.

In some implementations, the disclosed process may be applied in policy-governed structured decision systems, including security rule systems, compliance rule systems, and machine-enforced governance structures, in which the information structure comprises rules, governed entities, assignments, and defined relations among those elements. In such implementations, inconsistencies may correspond to contradictory rule effects, incompatible governed states, or mutually unsatisfiable structural conditions. Candidate transformations in the permitted subset that reduce the inconsistency measure may modify one or more governed elements or relationships under the defined process conditions to produce a resulting structure suitable for enforcement, validation, or continued machine operation.

### Support-System and User-Context Information Structures

In some implementations, the disclosed process operates over a support-system, journaling-support, coaching-support, workflow-support, decision-support, behavioral-context, or user-context information structure represented in machine-processable form. In such implementations, elements may correspond to represented events, obligations, constraints, contextual observations, decision options, decision constraints, support conditions, recovery-related conditions, unexpected-disruption records, preventable-disruption records, user-selected responsibilities, or other machine-represented state information. Relationships may correspond to dependency, support, conflict, burden, incompatibility, temporal, priority, recovery-related, decision-related, or context-related relationships among such elements.

In such implementations, inconsistencies may correspond to incompatible represented state conditions, conflicting decision-state relations, mutually unsatisfied support conditions or recovery-related conditions, incompatible priority or burden relationships, or other structural conditions that cannot simultaneously be satisfied under a defined incompatibility condition. The inconsistency measure may be used as a bounded computational indicator of represented structural deviation, structural dissonance, represented burden, decision-state conflict, recovery conflict, or represented escalation-risk within the information structure. Candidate transformations in the permitted subset may modify, deactivate, reclassify, defer, quarantine, escalate, substitute, prioritize, or otherwise change one or more represented elements, relationships, attributes, states, or substructures under the defined process conditions. A resulting information structure may be stored, displayed, supplied to a downstream software module, used to control a support-system interface, used for journaling-support, coaching-support, workflow-support, or decision-support functions, or used to generate a state-transition trace record.

This implementation is non-limiting and does not require or provide clinical diagnosis, medical treatment, psychological assessment, therapeutic efficacy, or determination of a medical or mental-health condition unless separately implemented, validated, and claimed.

In one non-limiting implementation, the invention may correspond to a support-system or user-context information structure, and the state-transition trace record may be generated as a structured runtime trace. The field names, identifiers, labels, and values described in this paragraph are representative of that implementation and do not require other embodiments to use the same names, labels, values, ordering, schema, runtime environment, or storage format.

At the beginning of the process, an initial iteration, the information structure may include an obligation element, an unexpected-disruption-record element, a support-condition element, and a decision-option element. An obligation element may represent an immediate task. An unexpected-disruption-record element may represent interruption of an available attention window. A support-condition element may represent a condition requiring a lower-burden next step. A decision-option element may represent deferral of noncritical work and production of one immediate next action.

The relationship records may include a burden relationship between the obligation and the disruption record, a support relationship between the support condition and the decision option, and a decision-related substitutes-for relationship between the decision option and the obligation. An active inconsistency record may identify an incompatible priority or burden relationship affecting the obligation, disruption record, and support condition.

In a representative trace, an inconsistency measure before transformation may be calculated. Candidate transformations may include prioritizing the support condition, deferring the obligation, substituting the decision option, quarantining the disruption record, and escalating support. Candidate-test data may identify post-transformation measures, reduction values, association status, valid-structure status, process-condition satisfaction status, reduction status, permitted status, and exclusion reasons.

The selected transformation may prioritize support by modifying the immediate obligation into a deferred/prioritized-support state under the support condition. In some cases, after reevaluation of the updated information structure, no active inconsistency record may remain, the inconsistency measure may be zero, and the trace may identify a resolved termination status.

This representative trace is non-limiting and illustrates a user-context information structure without requiring clinical diagnosis, medical treatment, psychological assessment, therapeutic efficacy, or determination of a medical or mental-health condition.

Across the foregoing implementations, the disclosed process remains a processor-implemented or computer-implemented inconsistency-resolution process operating over a machine-processable evolving information structure, detecting inconsistency under a defined incompatibility condition, determining under defined process conditions and with respect to an inconsistency measure a permitted subset of candidate transformations, applying a selected candidate transformation from the permitted subset that reduces the inconsistency measure to modify the structure, iterating that process, and terminating when no further permitted candidate transformations that reduce the inconsistency measure remain available under the defined process conditions. The specific implementation environment, representation form, element type, relationship type, incompatibility condition, and transformation class may vary without departing from the disclosed invention.

### 12. Boundary Statement

The specific mechanisms used to define advanced conditions governing determination of the permitted subset under the defined process conditions, prioritize or optimize transformation selection, represent inconsistency internally, or provide enhanced ordering-divergence reduction, convergence, or invariance properties beyond the application-facing selection mechanisms disclosed herein are implementation-dependent and not required for practicing the claimed invention.

### Structural Support and Implementation Scope

The disclosed invention is a structurally defined class of processor-implemented or computer-implemented methods and systems for resolving inconsistency within an information structure. The invention is described at a structurally defined level sufficient to identify its operative components, process conditions, and implementation scope. It is not described as a mere objective of making data consistent, but as a defined process operating over an information structure comprising elements and relationships, detecting inconsistency under a defined incompatibility condition, determining under defined process conditions and with respect to an inconsistency measure of the information structure a permitted subset of candidate transformations, applying a selected candidate transformation from the permitted subset that reduces the inconsistency measure to modify the structure, iterating that process, and reaching a termination condition corresponding to a state in which no further permitted candidate transformations that reduce the inconsistency measure remain available under the defined process conditions.

The disclosure shows possession of this claimed processor-implemented or computer-implemented process by identifying the structural components that make up the invention: the information structure, the elements within that structure, the relationships among those elements, the defined incompatibility condition, the inconsistency-detection stage, the candidate transformation set, the determination under defined process conditions of a permitted subset distinguished from non-permitted candidate transformations, the inconsistency measure by reference to which that permitted-subset determination is made, the iterative application of selected transformations, and the defined termination and stable-result conditions. These are disclosed as interrelated parts of one process rather than as isolated or aspirational outcomes.

In some embodiments, the disclosure further shows possession of preprocessing, trace-record, and output-related features including conversion of received input into a machine-processable information structure, determination that the structure satisfies a predefined condition indicating that inconsistency-resolution processing should be performed, generation or storage of a state-transition trace record for one or more iterations, and storage of the resulting information structure in memory before output.

The disclosed invention is further bounded by the representation classes expressly identified in the embodiment, including set-based, graph-based, logical, and constraint-based forms. Within those forms, the invention remains the same class of process: inconsistency is identified in a structured arrangement of elements, a permitted subset of candidate transformations is determined under defined process conditions and with respect to an inconsistency measure, a selected candidate transformation from the permitted subset that reduces the inconsistency measure modifies the structure iteratively, and the process stops under a defined termination condition.

The disclosed process therefore defines a specific class of inconsistency-resolution systems and methods having identifiable structural content and stated operating conditions. It is not an arbitrary repair engine, not a generic rewrite loop, and not an unconstrained cleanup process.

### Termination Conditions Section

The disclosed termination logic uses an inconsistency measure defined over the information structure.

The inconsistency measure is bounded because it is defined over the information structure and reflects detected inconsistencies within that structure. Under the disclosed embodiment, the measure is reduced by at least one permitted candidate transformation that reduces the inconsistency measure in any non-stable state under the defined process conditions.

Permitted candidate transformations that reduce the inconsistency measure produce monotone or strict descent under the disclosed conditions because the determination of the permitted subset requires that a transformation not increase the number of detected inconsistencies and satisfy a monotonic descent condition with respect to a defined inconsistency measure.

Finite termination holds under the disclosed conditions that: ⋅the inconsistency measure is bounded over a finite or discrete state space, ⋅permitted candidate transformations that reduce the inconsistency measure under the defined process conditions enforce monotonic descent, and ⋅at least one permitted candidate transformation that reduces the inconsistency measure is available in any non-stable state under the defined process conditions.

Finite termination is not claimed outside the disclosed conditions. It is not claimed where the stated bounded inconsistency measure or monotonic descent condition is absent, or where the disclosed conditions governing determination of the permitted subset and termination are not satisfied.

### Transformation-Order Divergence Reduction Section

The property claimed is that, under stated conditions, deterministic or globally consistent selection may reduce divergence caused by arbitrary transformation ordering.

This property is claimed only under the disclosed conditions that candidate transformations are evaluated under the same defined process conditions and with respect to the same inconsistency measure, and that selection is governed by a deterministic selection rule, global evaluation metric, or predefined tie-breaking procedure.

The disclosed abstract conditions supporting this property include: ⋅a deterministic selection rule, ⋅a global evaluation metric applied to candidate outcomes, or ⋅a predefined tie-breaking procedure.

Transformation-order convergence is not claimed universally and is not required for all embodiments. The disclosed property does not require every possible transformation sequence to reach the same result and does not require all possible transformation orders to produce an identical final structure.

The disclosed property is not claimed where deterministic or globally consistent selection is absent, where the defined process conditions are not satisfied, or where arbitrary ordering alone determines which permitted candidate transformation is selected.

### Traceable State-Transition Record Section

In some embodiments, the processor may generate a state-transition trace record for one or more iterations of the disclosed process. The state-transition trace record may identify a current information structure, one or more detected inconsistencies, one or more affected loci, an inconsistency measure before application of a selected candidate transformation, candidate transformations evaluated for the detected inconsistency, one or more test information structures, post-transformation inconsistency measures for one or more candidate transformations, the permitted subset of candidate transformations, the selected candidate transformation, the updated information structure, and a termination status.

In some embodiments, the state-transition trace record may identify a candidate transformation excluded from the permitted subset and may associate the exclusion with failure to satisfy an association condition, a valid-structure condition, a defined process condition, or a reduction condition requiring reduction of the inconsistency measure.

In some embodiments, the termination status may indicate that the resulting information structure is resolved when no active inconsistency remains. In other embodiments, the termination status may indicate that the resulting information structure is stable with remaining inconsistency when no further permitted candidate transformation that reduces the inconsistency measure remains available under the defined process conditions.

The state-transition trace record may be stored in memory, displayed, returned through an application programming interface, supplied to a downstream software module, used to control a subsequent machine action, or used as an updated reasoning-state structure.

In some embodiments, the state-transition trace record may identify a reduction value calculated for one or more tested candidate transformations.

This trace-record embodiment is application-facing and non-limiting. The trace record may be implemented using any suitable machine-processable record, data structure, storage format, event object, table entry, memory structure, application programming interface response, or software procedure, and does not require any particular internal scoring procedure, ordering procedure, selection procedure, validation procedure, storage procedure, or runtime implementation beyond the disclosed process.

The trace-record fields described above are illustrative. A trace record need not include every listed field unless expressly required by a claim, and different embodiments may include different combinations of detected-inconsistency data, candidate-test data, measure data, reduction data, permitted-subset data, selected-transformation data, updated-structure data, termination-status data, or output data.

In one non-limiting implementation, the state-transition trace record is generated as a structured runtime trace. The field names, identifiers, labels, and values described in this paragraph are representative of that implementation and do not require other embodiments to use the same names, labels, values, ordering, schema, runtime environment, or storage format.

In such an implementation, the trace record may include profile metadata, schema metadata, an iteration index, a current information structure, element records, relationship records, active inconsistency records, an inconsistency measure before transformation, candidate transformations, candidate-test data, a permitted subset, a selected transformation, an updated information structure, a final measure, and a termination status.

For example, a representative trace may identify a local-only reasoning profile, a trace schema, a schema version, a resolved termination status, a final measure of zero, and one completed iteration. The current information structure may include active element records corresponding to a user constraint, a model-proposed action, a tool output, a local-only rule, and a local candidate action. The user-constraint element may require local file operations and prohibit external API calls. The model-proposed-action element may require an external cloud API call. The tool-output element may indicate that the requested file or task context is available locally. The local-only-rule element may state that external cloud API calls are not permitted when local-only operation is required. The local-candidate-action element may represent inspection or processing using a local operation.

The relationship records may include a prohibition relationship from the user constraint to the model-proposed action, a support relationship from the tool-output element to the local candidate action, an applies-to relationship from the local-only rule to the user constraint, and a substitutes-for relationship from the local candidate action to the model-proposed action. The active inconsistency record may identify a local-only violation having an affected locus including the user constraint, the model-proposed action, and the local-only rule, and may assign the violation a weight value of one.

The candidate transformations may include modifying the proposed action to use local operations, substituting the proposed action with the local candidate action, deactivating the proposed external action, or marking the proposed external action as non-permitted. Candidate-test data may identify, for each tested candidate transformation, a transformation identifier, an operation description, a post-transformation inconsistency measure, a reduction value, an association indicator, a valid-structure indicator, a process-condition-satisfied indicator, a reduction indicator, a permitted indicator, exclusion reasons, and a test information structure.

In one representative trace, a candidate transformation corresponding to substitution of the proposed external action with the local candidate action produces a post-transformation inconsistency measure of zero, a reduction value of one, association with the active inconsistency record, valid-structure status, process-condition satisfaction, reduction of the inconsistency measure, permitted status, and no exclusion reason. The permitted subset may include the local modification, local substitution, deactivation, and non-permitted-marking transformations. The selected transformation may be the local substitution transformation. Applying that transformation changes the active model action to a local candidate action that does not require an external cloud API. A subsequent trace state may identify no active inconsistency records, an inconsistency measure of zero, an empty candidate-transformation set, an empty permitted subset, and a resolved termination status.

This trace example is non-limiting and illustrates one machine-processable implementation of the state-transition trace record described herein.

### Common-Principle Generalization Section

The common process principle unifying the disclosed logical, constraint, and graph embodiments is a processor-implemented or computer-implemented inconsistency-resolution process operating over an information structure composed of elements and relationships, in which inconsistency is detected under a defined incompatibility condition, a permitted subset of candidate transformations is determined under defined process conditions and with respect to an inconsistency measure of the information structure, a selected candidate transformation from the permitted subset that reduces the inconsistency measure modifies the structure, the process is iterated, a resulting structure is produced at termination, and, in some embodiments, a state-transition trace record is generated for one or more iterations of the process.

Across logical, graph, and constraint embodiments, the following remain invariant: ⋅existence of an information structure, ⋅existence of elements within that structure, ⋅existence of relationships among those elements, ⋅detection of inconsistency under a defined incompatibility condition, ⋅availability of candidate transformations, ⋅determination, under defined process conditions and with respect to an inconsistency measure, of a permitted subset of candidate transformations, ⋅iterative modification of the structure, ⋅use of an inconsistency measure, and ⋅a defined termination condition producing a resulting output. In embodiments that generate a state-transition trace record, the trace record may identify one or more of the foregoing process features for one or more iterations.

What may vary by implementation includes: ⋅representation form, the particular elements and relationships used, ⋅the specific form of the incompatibility condition, ⋅the specific form of candidate transformations, and ⋅the particular software or computational framework used to realize the process.

Across the disclosed implementations, the invention remains defined by the following common process features: ⋅the presence of a structured information domain, ⋅detection of inconsistency under a defined incompatibility condition, ⋅transformation-based modification of the structure, ⋅selection of candidate transformations from a permitted subset under the disclosed process conditions, ⋅iterative processing, and ⋅termination under the disclosed abstract conditions.

### Negative-Boundary Section

The claimed invention is not an arbitrary inconsistency-removal engine that removes elements without a defined incompatibility condition, without a defined candidate transformation set, or without determination, under defined process conditions and with respect to an inconsistency measure of the information structure, of a permitted subset of candidate transformations distinguished from non-permitted candidate transformations.

The claimed invention is not a generic graph-rewrite system that applies arbitrary rewrite rules without the disclosed inconsistency-detection, transformation-evaluation, and termination structure.

The claimed invention is not an arbitrary rule-based repair loop lacking the disclosed structure of: ⋅an information structure, ⋅detected inconsistency under a defined incompatibility condition, ⋅candidate transformations, ⋅selection from a permitted subset of candidate transformations under defined process conditions, ⋅iterative modification, and ⋅a stated termination condition.

The claimed invention is not an arbitrary constraint-cleanup system lacking the disclosed permitted-subset structure under defined process conditions, bounded inconsistency measure, and stated conditions for termination and, where claimed, transformation-order divergence reduction. Where a state-transition trace record is generated, the claimed invention is not a generic activity log or free-form explanation disconnected from the disclosed inconsistency-resolution process. Rather, the trace record is associated with one or more process features such as detected inconsistency, affected locus, inconsistency measure, candidate transformation testing, permitted-subset determination, selected transformation, updated information structure, termination status, or resulting structure.

### Application-Facing Construction Formula Embodiment

### Non-Limiting Example Based on the Disclosed Process Architecture

This embodiment is based on the disclosed process architecture and provides one non-limiting construction-level implementation framework.

This embodiment is explanatory and is not intended to define or limit the full scope of the invention.

The formulas, variables, records, functions, measures, test structures, reduction values, and trace-record fields described in this embodiment provide one application-facing implementation floor for explaining and enabling the disclosed process. They are not intended to define the ceiling of the invention or to require that every embodiment calculate, store, represent, or output each illustrated variable, record, function, measure, test structure, reduction value, or trace-record field.

### Non-Limiting Representation

The tuple, set, function, predicate, and record notation used in this embodiment is explanatory notation for one non-limiting implementation. It is not intended to require that the information structure be stored or processed as a tuple, set, object record, graph, table, or any other particular data type.

In other embodiments, the information structure may be represented using one or more graphs, object models, relational tables, document stores, key-value stores, rule structures, constraint stores, proposition structures, knowledge graphs, dependency graphs, configuration states, policy states, program-analysis states, or other machine-processable structures.

The disclosed process is defined by operations performed over the information structure, including detecting inconsistency under defined incompatibility conditions, evaluating candidate transformations with respect to an inconsistency measure, determining a permitted subset, applying a selected permitted transformation, iterating over the modified structure, terminating when no further permitted reducing transformation remains available, and outputting a resulting information structure. The process is not limited to the explanatory notation used in this embodiment.

The notation Parse(X), Class(u_j), IdentifyRelationships(E), TransformClasses(t_{i,l}, l), CandidateTransformations(a_{i,l}, S_k), ApplyToCopy(T, S_k), and Apply(T, S_k) is used to describe example software operations. These operations may be implemented using rule-based parsing, schema mapping, extraction logic, model-assisted classification, graph construction logic, constraint loading, database ingestion, ordinary software procedures, or other known machine-processing techniques.

For any implementation, the domain mapping may be performed by identifying machine-processable domain objects as elements, identifying associations, dependencies, constraints, classifications, or other structural links as relationships, defining incompatibility conditions capable of being evaluated over the elements and relationships, defining candidate transformations associated with detected inconsistency types and affected loci, and defining an inconsistency measure capable of comparison before and after candidate transformation. Once these implementation-specific mappings are supplied, the disclosed process proceeds according to the same formula-defined state-transition architecture. The disclosed embodiments are representative implementations of the same operative architecture rather than separate invention boundaries; the domain-specific mappings may vary, while the common inconsistency-resolution process remains invariant.

### FIG. 2 Process Flow Correspondence

FIG. 2 illustrates an example process flow for resolving inconsistency within an information structure. The following correspondence identifies how the operations shown in FIG. 2 may be implemented in the application-facing construction formula embodiment. This correspondence is explanatory only and is not intended to limit the process to the notation, data structures, or example operations used in the formula embodiment.

The “receive input structure 132” operation in FIG. 2 corresponds, in one implementation, to the formation of input units and element records from received input X. In the formula embodiment, this is represented by input-unit formation, input-unit classification, and element-record construction, including U=Parse(X), Class(u_j), and creation of element records E_0.

The “identify relationships 152” operation in FIG. 2 corresponds, in one implementation, to relationship-record construction. In the formula embodiment, this is represented by R_0=IdentifyRelationships(E_0), where relationship records may identify associations, dependencies, support relations, contradiction bases, potential incompatibilities, prohibitions, overrides, or other machine-processable relationship representations.

The “detect inconsistency 136” operation in FIG. 2 corresponds, in one implementation, to evaluation of defined incompatibility conditions over the current information structure S_k. In the formula embodiment, this is represented by the defined incompatibility-condition set C, loci L_i(S_k), violation indicators v_i(S_k, l), and construction of active inconsistency records A_k.

The “evaluate candidate transformations 138” operation in FIG. 2 corresponds, in one implementation, to calculating the inconsistency measure I(S_k), identifying candidate transformations Cand_k associated with active inconsistency records, forming test information structures S_k\hat{ }T, evaluating incompatibility conditions over the test structures, calculating I(S_k\hat{ }T), and applying association, validity, and process-condition tests.

The “select transformation 140” operation in FIG. 2 corresponds, in one implementation, to determining the permitted subset P_k and selecting a permitted transformation T*_k from that subset. In the formula embodiment, P_k includes candidate transformations that are associated with at least one active inconsistency record, produce a valid test information structure, satisfy the defined process conditions, and reduce the inconsistency measure. Selection may be represented by an application-facing rule such as T*_k∈P_k or, in one non-limiting example, T*_k=arg min_{T∈P_k} I(S_k\hat{ }T), with a predefined tie-breaking procedure where multiple candidates produce the same resulting inconsistency measure.

The “apply transformation 142” operation in FIG. 2 corresponds, in one implementation, to applying the selected permitted transformation to the current information structure. In the formula embodiment, this is represented by S_{k+1}=Apply(T*_k, S_k).

The “update information structure 144” operation in FIG. 2 corresponds, in one implementation, to using the modified information structure S_{k+1} as the current structure for the next iteration. In the formula embodiment, this is represented by updating the structure and setting k←k+1 before repeating evaluation of incompatibility conditions, inconsistency records, the inconsistency measure, candidate transformations, the permitted subset, selection, and application.

The “termination test 146” and “termination condition 118 satisfied?” operations in FIG. 2 correspond, in one implementation, to determining whether P_k=∅, meaning that no candidate transformation associated with any currently detected inconsistency type and affected locus both satisfies the defined process conditions and reduces the inconsistency measure. In some embodiments, I(S_k)=0 may independently indicate termination where no active inconsistency records remain.

The “output structure 134” operation in FIG. 2 corresponds, in one implementation, to outputting S_final as the resulting machine-processable information structure. In the formula embodiment, S_final=S_k at termination and may include final element records, final relationship records, remaining active inconsistency records if any, final inconsistency measure, termination status, resulting structure data, and, in some embodiments, a state-transition trace record associated with one or more iterations of the process.

### I. Input and Input-Unit Formation

Let:
X=received input text, input data, structured records, semi-structured records, tool output, model output, policy data, configuration data, graph data, proposition data, or other machine-processable or machine-convertible input.

In one implementation, the software may form input units from X:
U=Parse(X) Where: U={u_1, u_2, . . . , u_m}, and each u_j may be a sentence, clause, command, assertion, proposition, constraint, rule, tool output, state descriptor, structured field, or data record.

### II. Input-Unit Classification

In one implementation, the software may classify each input unit using an example classification operation:
Class(u_j)∈K_U
where K_U may include:
proposition
constraint
rule
action
proposed_action
evidence
tool_output
state_descriptor
data_record

Example classification rules may include:
If u_j includes language indicating obligation, prohibition, requirement, or necessity, Class(u_j) may be constraint.
If u_j describes a proposed operation, step, command, or behavior, Class(u_j) may be action or proposed_action.
If u_j defines a category, exclusion, condition, or rule, Class(u_j) may be rule.
If u_j reports an observed result, Class(u_j) may be evidence, tool_output, or state_descriptor.

### III. Element-Record Construction

In one implementation, for each input unit u_j, the software may create an element record:

```
e_j = ElementRecord(
          element_id_j,
        text_or_value_j,
        element_type_j,
        attributes_j,
        source_j,
        status_j
  )
```

where:
element_id_j=identifier assigned to the element;
text_or_value_j=text, value, or structured content represented by u_j;
element_type_j=Class(u_j);
attributes_j=attributes extracted or assigned for u_j;
source_j=source of u_j;
status_j may indicate whether the element is active or inactive.

The element records at initialization may be represented as:

E_0={e_1, e_2, . . . , e_p}

This notation is explanatory only. Other implementations may store or represent elements using graph nodes, rows, objects, documents, records, memory entries, proposition entries, database entries, or other machine-processable forms.

### IV. Relationship-Record Construction

In one implementation, the software may create relationship records by comparing one or more element records according to example relationship-identification rules.

The relationship records may be represented as:

R_0=IdentifyRelationships(E_0)
where each relationship record may have the form:

```
r_ab = RelationshipRecord(
        relationship_id_ab,
        source_element_id_a,
        target_element_id_b,
        relationship_type_ab,
        basis_ab,
        status_ab,
        attributes_ab
  )
```

where relationship_type_ab may include:
classification
requirement_applies_to
support
dependency
contradiction
potential_incompatibility
prohibition
override

A relationship may be created when two or more elements share or implicate a subject, action, resource, requirement, dependency, classification, support basis, contradiction basis, or incompatibility basis.

This notation is explanatory only. Other implementations may represent relationships as edges, links, records, table entries, constraints, pointers, references, predicates, metadata, or other machine-processable relationship representations.

### V. Information Structure

In one explanatory implementation, the current machine-processable information structure at iteration k may be represented as:

S_k=(E_k, R_k, C, A_k)
where:
E_k represents element records at iteration k; R_k represents relationship records at iteration k; C represents defined incompatibility conditions; A_k represents active inconsistency records at iteration k.

At initialization, the information structure may be represented as:

S_0=(E_0, R_0, C, A_0)
where A_0 may be empty until incompatibility conditions are evaluated.

This tuple notation is explanatory only. In other embodiments, the information structure may be implemented using a graph, object model, relational table, document store, key-value store, rule structure, constraint store, proposition structure, knowledge graph, dependency graph, configuration state, policy state, program-analysis state, or other machine-processable representation. The disclosed process is not limited to tuple-form data structures.

### VI. Incompatibility Conditions

In one implementation, the defined incompatibility conditions may be represented as:

C={c_1, c_2, . . . , c_n}
where each c_i is an evaluable incompatibility condition over one or more elements, relationships, attributes, constraints, state descriptors, or substructures of S_k.

For each c_i, the software may identify loci at which c_i is evaluated:
L_i(S_k)=set of identifiable loci in S_k at which c_i is evaluated.

A locus l in L_i(S_k) may identify:
one or more elements;
one or more relationships;
one or more attributes;
one or more constraints;
one or more state descriptors;
one or more substructures;
or any combination thereof.

### VII. Violation Indicator

For each incompatibility condition c_i and locus l in L_i(S_k), an example violation indicator may be represented as:
v_i(S_k, l)=1 if c_i is violated at locus l in S_k.
v_i(S_k, l)=0 otherwise.

The indicator notation is explanatory only. Other implementations may store violations as records, flags, predicates, rule outputs, graph annotations, table entries, or other machine-processable representations.

### VIII. Inconsistency-Record Construction

For each pair (c_i, l) where:

v_i(S_k, l)=1
the software may create an inconsistency record:

```
a_{i,l} = InconsistencyRecord(
          violated_condition = c_i,
          affected_locus = l,
          inconsistency_type = t_{i,l},
          involved_elements = E_l,
          involved_relationships = R_l,
          weight = w_{i,l},
          status = active
  )
```

where:
c_i represents the violated incompatibility condition;
l represents the affected locus;
t_{i,l} represents the detected inconsistency type;
E_l represents involved elements at locus l;
R_l represents involved relationships at locus l;
w_{i,l} represents an example weight associated with the detected violation;
status may indicate whether the inconsistency record is active or inactive.

The active inconsistency-record set at iteration k may be represented as:

A_k={a_{i,l}:v_i(S_k, l)=1}

This notation is explanatory only. Other implementations may store detected inconsistencies using flags, events, database records, graph annotations, rule outputs, logs, memory entries, or other machine-processable representations.

### IX. Inconsistency Measure

One exemplary application-facing inconsistency measure may be calculated as the sum of weights of active inconsistency records in S_k:

I(S_k)=Σ_{a_{i,l}∈A_k}w_{i,l}

Equivalently, using violation indicators:

I(S_k)=Σ_iΣ_{l∈L_i(S_k)}w_{i,l}·v_i(S_k,l)
where: w_{i,l} represents an example weight associated with incompatibility condition c_i at locus l;
v_i(S_k,l) represents whether c_i is violated at locus l in S_k.

The weighted-sum measure is one example of an inconsistency measure. Other embodiments may use counts, normalized scores, constraint-violation costs, graph-violation weights, priority-adjusted scores, category-specific violation measures, or other bounded measures capable of comparison before and after candidate transformation.

This is an application-facing example calculation and does not require use of any particular internal scoring method.

### IX-A. Inconsistency-Measure Quantification

In one non-limiting implementation, the inconsistency measure may be calculated by evaluating defined incompatibility conditions at corresponding loci of the current information structure and summing violation values or weighted violation values associated with detected violations.

Let S_k represent the current machine-processable information structure at iteration k.

Let C={c_1, c_2, . . . , c_n} represent defined incompatibility conditions.

For each incompatibility condition c_i, let L_i(S_k) represent the set of loci in S_k at which c_i is evaluated.

For each locus l∈L_i(S_k), define a violation indicator:
v_i(S_k, l)=1 when incompatibility condition c_i is violated at locus l in S_k;
v_i(S_k, l)=0 otherwise.

Each violation may be associated with an application-facing weight w_i,l. The weight may be a fixed value, category-specific value, priority-adjusted value, constraint-violation cost, graph-violation value, policy-conflict value, or another bounded value associated with the detected incompatibility-condition violation.

An exemplary raw inconsistency measure may be calculated as:

I_raw(S_k)=Σ_iΣ_{l∈L_i(S_k)}w_i,l·v_i(S_k,l)
where I_raw(S_k) represents a raw inconsistency measure of the current information structure.

In an unweighted embodiment, w_i, l may be set to 1 for each detected violation, such that I_raw(S_k) corresponds to a count of active detected incompatibility-condition violations.

In some embodiments, the inconsistency measure may be normalized to a bounded scale, such as a scale from 0 to 100, where 0 indicates that no active inconsistency is detected under the defined incompatibility conditions and 100 indicates a maximum or reference inconsistency value under a defined reference scale for the embodiment.

A normalized inconsistency measure may be calculated as:

I_norm(S_k)=min(100, 100·I_raw(S_k)/I_ref)
where I_ref is a nonzero defined reference value for the embodiment.

For a candidate transformation T, the processor may form a test information structure:

S_k\hat{ }T=ApplyToCopy(T, S_k)

The processor may then calculate a post-transformation raw inconsistency measure:

I_raw(S_k\hat{ }T)=Σ_iΣ_{l\hat{ }T∈L_i(S_k\hat{ }T)}w_i,l\hat{ }T·v_i(S_k\hat{ }T, l\hat{ }\hat{ }T)

The processor may also calculate a post-transformation normalized inconsistency measure:

I_norm(S_k\hat{ }T)=min(100, 100·I_raw(S_k\hat{ }T)/I_ref)

The candidate transformation T may be treated as reducing the inconsistency measure when:

I_raw(S_k\hat{ }T)<I_raw(S_k)
or, in a normalized embodiment, when:

I_norm(S_k\hat{ }T)<I_norm(S_k)

The processor may use this before-and-after comparison to determine whether T is included in the permitted subset under the defined process conditions.

For example, if S_k includes one active violation of an incompatibility condition with weight 1, then I_raw(S_k)=1. If applying candidate transformation T to a test structure eliminates that violation and no additional violation is detected, then I_raw(S_k\hat{ }T)=0, and T reduces the inconsistency measure.

If S_k includes three active violations having weights 1, 2, and 1, then I_raw(S_k)=1+2+1=4. If applying candidate transformation T produces a test structure having two active violations with weights 1 and 1, then I_raw(S_k\hat{ }T)=1+1=2. Because I_raw(S_k\hat{ }T)<I_raw(S_k), T reduces the inconsistency measure in this example.

This inconsistency-measure quantification is application-facing and non-limiting and may be implemented using any suitable bounded measure, comparison procedure, or computational framework consistent with the disclosed process.

The raw and normalized formulas are examples of bounded inconsistency-measure calculations and do not exclude embodiments using other bounded or comparable inconsistency measures capable of evaluating reduction before and after candidate transformation.

### IX-B. Inconsistency-Reduction Control Function

In some embodiments, the inconsistency measure may operate as a transition-control value for determining whether a candidate transformation is permitted to modify the current information structure.

For a current information structure S_k and a candidate transformation T, the processor may form a test information structure:

S_k\hat{ }T=ApplyToCopy(T, S_k)

The processor may calculate a reduction value:

ΔI_raw(T, S_k)=I_raw(S_k)−I_raw(S_k\hat{ }T)
where I_raw(S_k) is the raw inconsistency measure before application of candidate transformation T, and I_raw(S_k\hat{ }T) is the post-transformation raw inconsistency measure for the test information structure.

In a normalized embodiment, the processor may calculate:

ΔI_norm(T, S_k)=I_norm(S_k)−I_norm(S_k\hat{ }T)

In a strict-reduction embodiment, candidate transformation T is eligible for inclusion in the permitted subset only when:

ΔI_raw(T, S_k)>0
or, in a normalized embodiment, when:

ΔI_norm(T, S_k)>0

Equivalently, the post-transformation inconsistency measure must be lower than the inconsistency measure of the current information structure.

A candidate transformation for which the reduction value is less than or equal to zero may be excluded from the permitted subset under the defined process conditions because the candidate transformation does not reduce the inconsistency measure.

In some embodiments, where a plurality of candidate transformations have positive reduction values, the processor may select a candidate transformation from the permitted subset using an application-facing selection rule, deterministic ordering, global evaluation metric, or predefined tie-breaking procedure.

The reduction-control function may be used to prevent arbitrary, non-reducing, or inconsistency-increasing candidate transformations from being applied to the information structure under the disclosed process conditions. Where the information structure is a structured reasoning-state structure associated with an artificial-intelligence system, the reduction-control function may constrain modification of the reasoning-state structure so that selected permitted transformations reduce the inconsistency measure under the defined process conditions.

This reduction-control embodiment does not require that all possible model outputs, all possible reasoning paths, or all possible transformation orders converge to an identical final structure. The embodiment also does not require that all positive inconsistency values be reducible. If no permitted candidate transformation remains available that reduces the inconsistency measure, the process may terminate with a termination status indicating stable with remaining inconsistency.

This reduction-control function is application-facing and non-limiting and may be implemented using any suitable comparison procedure, control condition, data representation, or computational framework consistent with the disclosed process.

The reduction-value notation is explanatory and does not require that every embodiment separately store or expose a reduction value, provided that the embodiment determines whether a candidate transformation reduces the inconsistency measure under the defined process conditions.

### X. Candidate-Transformation Identification

For each active inconsistency record:

a_{i,l}∈A_k
the software may identify candidate transformations associated with:
t_{i,l}=detected inconsistency type;
l=affected locus.

In one explanatory implementation, the software may use an application-facing mapping:
TransformClasses(t_{i,l}, l)
which maps a detected inconsistency type and affected locus to one or more candidate-transformation classes.
Candidate-transformation classes may include:
modify_element
substitute_element
deactivate_element
remove_relationship
relabel_relationship
split_element
merge_elements
quarantine_element
mark_non_permitted
substitute_dependency
reassign_resource

For each transformation class associated with a_{i,l}, the software may instantiate one or more candidate transformations:

T∈CandidateTransformations(a_{i,l}, S_k)

The candidate-transformation set for iteration k may be represented as:

Cand_k=∪_{a_{i,l}∈A_k} CandidateTransformations(a_{i,l}, S_k)

Candidate transformations are associated with detected inconsistency type and affected locus. They are not arbitrary neighboring states. The transformation notation is illustrative and does not require any particular programming language, storage format, object class, record schema, graph operation, or data representation.

### XI. Test-Structure Formation

For each candidate transformation:

T∈Cand_k
the software may form a test information structure by applying T to a copy of S_k:

S_k\hat{ }T=ApplyToCopy(T, S_k)

The software may evaluate defined incompatibility conditions over S_k\hat{ }T.

The software may create active test inconsistency records:

A_k\hat{ }T={a_{i,l\hat{ }T}:l\hat{ }T∈L_i(S_k\hat{ }T) and v_i(S_k\hat{ }T, l\hat{ }T)=1}

The software may calculate the test inconsistency measure:

I(S_k\hat{ }T)=Σ_{a_{i,l\hat{ }T}∈A_k\hat{ }T}w_{i,l\hat{ }T}

This notation is explanatory only. A test structure may be implemented as a copied graph, copied object state, temporary table, staged update, transaction, simulation state, rule-evaluation state, or other machine-processable test representation.

### XII. Association, Validity, And Process-Condition Tests

In one implementation, the following application-facing tests may be used.

Associated(T, a_{i,l})=1
if T is associated with the detected inconsistency type t_{i,l} and affected locus l of active inconsistency record a_{i,l}.

Otherwise:

Associated(T, a_{i,l})=0.

ValidStructure(S_k\hat{ }T)=1
if S_k\hat{ }T is a valid machine-processable information structure after T is applied to a copy of S_k.

Otherwise:

ValidStructure(S_k\hat{ }T)=0.

ProcessConditionSatisfied(T, S_k, S_k\hat{ }T)=1
if T satisfies the defined process conditions for the embodiment when applied to S_k to form S_k\hat{ }T.

Otherwise:

ProcessConditionSatisfied(T, S_k, S_k\hat{ }T)=0.

ProcessConditionSatisfied(T, S_k, S_k\hat{ }T) is an application-facing defined process-condition test and does not require use of any particular internal admissibility or selection method.

In one non-limiting implementation, candidate-test data for a candidate transformation is stored as a machine-processable record. The field names, identifiers, labels, and values described in this paragraph are representative only and do not require other embodiments to use the same names, labels, values, ordering, schema, runtime environment, or storage format.

A representative candidate-test-data record may include a transformation identifier, an operation description, a post-transformation inconsistency measure, a reduction value, an association indicator, a valid-structure indicator, a process-condition-satisfied indicator, a reduction indicator, a permitted indicator, one or more exclusion reasons, and a test information structure.

For example, a candidate-test-data record may correspond to substituting a proposed external action with a local candidate action. The record may indicate a post-transformation inconsistency measure of zero, a reduction value of one, association with an active inconsistency record, valid-structure status, satisfaction of the defined process conditions, reduction of the inconsistency measure, permitted status, and no exclusion reason.

A candidate transformation may be included in the permitted subset when the candidate-test-data record indicates association with an active inconsistency record, a valid test information structure, satisfaction of the defined process conditions, and reduction of the inconsistency measure. A candidate transformation may be excluded when the candidate-test-data record indicates failure of an association condition, failure of a valid-structure condition, failure of a defined process condition, or failure to reduce the inconsistency measure.

The candidate-test-data structure is non-limiting and may be implemented using records, objects, tables, graph annotations, event logs, serialized trace entries, memory structures, or other machine-processable data structures.

### XIII. Permitted Subset

In one implementation, the permitted subset at iteration k may be represented as:

```
P_k = {
        T ∈ Cand_k :
        there exists at least one active inconsistency record a_{i,l} ∈ A_k such that
        Associated(T, a_{i,l}) = 1
        and ValidStructure(S_k\hat{ }T) = 1
        and ProcessConditionSatisfied(T, S_k, S_k\hat{ }T) = 1
        and I(S_k\hat{ }T) < I(S_k)
  }
```

A candidate transformation T is included in P_k when:
T is associated with at least one active inconsistency record, including the detected inconsistency type and affected locus identified by that record;
T produces a valid test information structure;
T satisfies the defined process conditions for the embodiment;
and T reduces the inconsistency measure.

This permitted-subset notation is explanatory only and does not require any particular data structure for storing or evaluating the subset.

### XIV. Selection

If:

P_k≠∅
the software may select a permitted transformation:

T*_k∈P_k
using an exemplary application-facing selection rule.

One example selection rule is:

T*_k=arg min_{T∈P_k} I(S_k\hat{ }T)

If more than one candidate transformation produces the same resulting inconsistency measure, an example tie-breaker may select the first candidate in a predefined ordering.

This selection rule is an application-facing example and may be implemented using any suitable scoring procedure, ordering procedure, comparison procedure, tie-breaking procedure, or selection procedure consistent with the disclosed process. Other embodiments may select any permitted candidate transformation that reduces the inconsistency measure and satisfies the defined process conditions.

### XV. Application And Update

The software may apply the selected transformation to the current information structure:

S_{k+1}=Apply(T*_k, S_k)

The updated structure S_{k+1} may contain:
modified element records;
modified relationship records;
inactive records;
substituted records;
removed records;
new records;
or other transformed records resulting from T*_k.

This update notation is explanatory only and does not require any particular storage or update mechanism.

### XVI. Iteration

The software repeats the process on S_{k+1}.

Set:

k←k+1

Then the software may:
evaluate C over S_k;
construct A_k;
calculate I(S_k);
identify Cand_k;
form test structures S_k\hat{ }T;
determine P_k;
select T*_k if P_k is nonempty;
apply T*_k;
and update S_k.

### XVII. Termination

The process terminates when:

P_k=∅
meaning no candidate transformation associated with any currently detected inconsistency type and affected locus both satisfies the defined process conditions and reduces the inconsistency measure.

Termination at P_k=∅ may occur even if I(S_k) is greater than zero, where remaining inconsistencies have no candidate transformation that both satisfies the defined process conditions and reduces the inconsistency measure.

In some embodiments, I(S_k)=0 may independently indicate termination where no active inconsistency records remain.

At termination:

S_final=S_k

### XVIII. Output

The software outputs:
S_final
as the resulting machine-processable information structure.

The output may include:
final element records;
final relationship records;
remaining active inconsistency records, if any;
final inconsistency measure;
termination status;
and resulting structure data.

### XIX. State-Transition Trace Record

In some embodiments, the software may generate a state-transition trace record for one or more iterations of the process.

For iteration k, an example trace record may include:

```
Trace_k = {
        current_structure: S_k,
        active_inconsistency_records: A_k,
        inconsistency_measure_before: I(S_k),
        candidate_transformations: Cand_k,
        test_structures: {S_k\hat{ }T : T ∈ Cand_k},
        post_transformation_measures: {I(S_k\hat{ }T) : T ∈ Cand_k},
        permitted_subset: P_k,
        selected_transformation: T*_k,
        updated_structure: S_{k+1},
        termination_status: status_k
  }
```

The termination status may indicate, for example, whether no active inconsistency remains or whether no further permitted candidate transformation that reduces the inconsistency measure remains available under the defined process conditions.

The trace-record notation is explanatory only. The trace record may be implemented as a database record, graph annotation, structured log, event object, table entry, serialized data object, memory structure, API response, or other machine-processable record. This trace-record embodiment is application-facing and non-limiting and may be implemented using any suitable machine-processable record, data structure, storage format, or software procedure.

### Application-Facing Construction Level Embodiment

### Non-Limiting Example Based on the Disclosed Process Architecture

### Purpose

This section provides one non-limiting application-facing construction-level embodiment based on the disclosed process architecture. It is intended to provide an ordered example of how the disclosed steps may be performed by software.

This embodiment is provided for explanatory purposes and is not intended to limit the invention to the particular example implementation described below. It is not claim language and is not intended to define the full scope of the invention.

This embodiment is consistent with the disclosed process architecture and is provided as one non-limiting implementation example.

### 1. Overview

In one non-limiting embodiment, software receives input text and converts the input into a machine-processable information structure. The information structure includes elements and relationships. The software evaluates defined incompatibility conditions over the information structure to determine whether inconsistencies are present.

If an inconsistency is detected, the software identifies candidate transformations associated with the detected inconsistency type and the affected portion of the information structure. The software evaluates those candidate transformations with respect to an inconsistency measure, determines a permitted subset, selects a permitted transformation that reduces the inconsistency measure, applies the selected transformation, updates the information structure, and repeats the process until no further permitted inconsistency-reducing transformation remains available.

The software then outputs the resulting information structure and, in some embodiments, generates or outputs a state-transition trace record associated with one or more iterations of the process.

### 2. Ordered Sequence of Steps

In this embodiment, the software may perform the following sequence:
(1) receive input text or input data;
(2) segment the input into input units;
(3) classify the input units;
(4) create element records from the classified input units;
(5) identify relationship records among the element records;
(6) form a machine-processable information structure;
(7) evaluate defined incompatibility conditions over the information structure;
(8) create inconsistency records for detected violations;
(9) calculate an inconsistency measure;
(10) identify candidate transformations associated with the detected inconsistency type and affected locus;
(11) test candidate transformations on copies of the information structure;
(12) determine a permitted subset of candidate transformations;
(13) select a permitted transformation that reduces the inconsistency measure;
(14) apply the selected transformation to modify the information structure;
(15) repeat evaluation on the modified information structure;
(16) terminate when no further permitted reducing transformation remains available;
(17) generate a state-transition trace record identifying one or more detected inconsistencies, tested candidate transformations, before-and-after inconsistency measures, the permitted subset, the selected transformation, the updated information structure, and termination status; and
(18) output the resulting information structure.

### 3. Example Input

For purposes of illustration, the input may include the following text:
Input 1:“The operation must be performed locally.”
Input 2:“The proposed action calls an external cloud API.”
Input 3:“External cloud API calls are not local operations.”

This example is used only to illustrate the disclosed process architecture. Other embodiments may use access-control data, configuration data, policy data, graph data, logical propositions, tool outputs, model outputs, structured records, or other machine-processable information.

### 4. How Input Text Becomes Elements

The software may first segment the input into input units. An input unit may be a sentence, clause, command, assertion, proposition, constraint, rule, tool output, state descriptor, or structured data record.

The software may then classify each input unit using example classification rules. For example:
an input unit containing “must,” “must not,” “required,” or “shall” may be classified as a constraint or requirement;
an input unit describing a proposed operation or step may be classified as a proposed action;
an input unit defining a category, rule, exclusion, or condition may be classified as a rule;
an input unit reporting an observed result may be classified as evidence, tool output, or state data.

For the example:
Input 1 is classified as a constraint;
Input 2 is classified as a proposed action;
Input 3 is classified as a rule.

The software then creates element records.

Element E1:
text: “The operation must be performed locally.”
type: constraint
status: active
attribute: requires local-only operation

Element E2:
text: “The proposed action calls an external cloud API.”
type: proposed action
status: active
attribute: action uses external cloud API

Element E3:
text: “External cloud API calls are not local operations.”
type: rule
status: active
attribute: external cloud API calls are classified as non-local

In this manner, portions of the input become elements when they express propositions, constraints, rules, actions, conclusions, tool outputs, state descriptors, or other machine-processable content relevant to the information structure.

### 5. How Relationships are Created

The software may identify relationships by comparing element types, attributes, subjects, actions, resources, constraints, classifications, dependencies, and support bases.

In the example, the software may create the following relationships.

Relationship R1:
source: E3
target: E2
type: classification
basis: E3 classifies external cloud API calls as non-local, and E2 describes an external cloud API call.

Relationship R2:
source: E1
target: E2
type: requirement-applies-to
basis: E1 requires local-only operation, and E2 describes the proposed operation.

Relationship R3:
source: E2
target: E1
type: potential incompatibility
basis: E2 proposes an external cloud API call while E1 requires local-only performance.

Thus, portions of the input become relationships when the software determines that two or more elements share a subject, action, resource, requirement, dependency, classification, support relation, contradiction relation, or incompatibility basis.

### 6. Forming the Information Structure

The software stores the elements and relationships as a machine-processable information structure. For example, the initial information structure may include:
elements: E1, E2, E3;
relationships: R1, R2, R3;
defined incompatibility conditions; and
any detected inconsistency records.

The information structure may be implemented as a graph, proposition structure, object model, table, rule structure, constraint store, or other machine-processable representation.

### 7. How Incompatibility Conditions are Evaluated

The software evaluates defined incompatibility conditions over the elements and relationships. In the example, one incompatibility condition may be:

Condition C1 is violated when:
a local-only constraint is active;
a proposed action is active;
the proposed action uses an external cloud API;
a rule classifies external cloud API calls as non-local; and
the local-only constraint applies to the proposed action.

Applied to the example:
E1 is active and requires local-only operation;
E2 is active and proposes an external cloud API call;
E3 is active and classifies external cloud API calls as non-local;
R2 indicates that the local-only requirement applies to E2; and
R1 indicates that E2 is classified as non-local.

Therefore, condition C1 is violated.

### 8. How an Inconsistency Record is Created

When the software determines that an incompatibility condition is violated, it creates an inconsistency record.

For example, the inconsistency record may include:

Inconsistency Record ICR1:
violated condition: C1;
inconsistency type: local-only conflict;
involved elements: E1, E2, E3;
involved relationships: R1, R2, R3;
affected locus: the portion of the information structure involving E1, E2, E3, R1, R2, and R3;
status: active;
weight: 1.

The affected locus identifies where in the information structure the inconsistency occurs.

### 9. How Lacking Support, Contradiction and Relationship-Level Inconsistency may be Detected

The software may detect different inconsistency types using different defined incompatibility conditions.

An element may be determined to lack support when the element requires support and the information structure contains no active support relationship satisfying that requirement.

An element may be determined to contradict another element when both elements are active, concern the same subject, action, resource, or locus, and satisfy an incompatibility condition indicating mutually incompatible status, polarity, assignment, action, or requirement.

A relationship may itself result in an inconsistency when the relationship violates an incompatibility condition. For example:
a dependency relationship may point to a prohibited or unavailable element;
a support relationship may rely on a contradicted element;
a relationship may simultaneously require and prohibit the same condition at the same locus; or
a classification relationship may classify an action in a way that conflicts with a requirement applied to that action.

In each case, the software creates an inconsistency record identifying the violated condition, involved elements, involved relationships, affected locus, and inconsistency type.

### 10. How the Inconsistency Measure may be Calculated

In one embodiment, the inconsistency measure may be calculated by counting or weighting active inconsistency records.

For example, each active inconsistency record may be assigned an example weight. The inconsistency measure may be calculated as the sum of the weights of active inconsistency records.

In the example:
one inconsistency record is active: ICR1;
ICR1 has weight 1.

Therefore:

Initial inconsistency measure=1.

This may also be expressed as:

I(S)=sum of weights for active detected incompatibility-condition violations in S.

If an information structure contains three active violations having weights 1, 2, and 1, then:

I(S)=1+2+1=4.

In the present example:

I(S0)=1.

This is an exemplary application-facing calculation and does not require use of any particular internal scoring method.

### 11. How Candidate Transformations are Identified

After detecting an inconsistency, the software identifies candidate transformations associated with the detected inconsistency type and affected locus.

For the example, the detected inconsistency type is local-only conflict, and the affected locus includes E1, E2, E3, R1, R2, and R3.

Candidate transformations may include:

Candidate T1:
type: modify element;
target: E2;
operation: modify E2 so the proposed action uses a local operation instead of an external cloud API call.

Candidate T2:
type: substitute element;
target: E2;
operation: substitute E2 with a proposed local action.

Candidate T3:
type: deactivate element;
target: E2;
operation: mark E2 inactive.

Candidate T4:
type: mark non-permitted;
target: E2;
operation: mark the external cloud API action as non-permitted under the defined process conditions.

Candidate T5:
type: quarantine;
target: E2;
operation: mark E2 for review and prevent it from being used as an active proposed action.

Thus, the candidate transformations are not arbitrary neighboring states. They are associated with the detected inconsistency type and the affected locus in the information structure.

### 12. How Candidate Transformations are Tested

For each candidate transformation, the software applies the candidate transformation to a copy of the current information structure.

For example, candidate T1 modifies E2 from: “The proposed action calls an external cloud API.” to: “The proposed action uses a local operation.”

The software then evaluates the incompatibility conditions over the test structure. In the test structure produced by T1:
E1 still requires local-only operation;
E2 has been modified to use a local operation;
E3 still states that external cloud API calls are not local operations; and
E2 is no longer an external cloud API call.

Therefore, condition C1 is no longer violated in the test structure.

The inconsistency measure for the test structure is:

I(test structure for T1)=0.

### 13. How the Permitted Subset is Determined

The software determines a permitted subset of candidate transformations.

In this example, a candidate transformation is included in the permitted subset when:
(1) the candidate transformation is associated with the detected inconsistency type and affected locus;
(2) the candidate transformation produces a valid test information structure;
(3) the candidate transformation satisfies the defined process conditions for the embodiment; and
(4) the candidate transformation reduces the inconsistency measure.

For T1:
T1 is associated with the local-only conflict;
T1 targets the affected proposed-action element E2;
T1 produces a valid test structure;
T1 reduces the inconsistency measure from 1 to 0.

Therefore, T1 is included in the permitted subset.

### 14. How a Permitted Transformation is Selected

The software selects one transformation from the permitted subset using an exemplary selection rule.

For example, the software may select the candidate that produces the lowest resulting inconsistency measure. If multiple candidates produce the same resulting measure, the software may select the first candidate in a predefined ordering.

In the example, T1 reduces the inconsistency measure from 1 to 0. If no other candidate produces a lower value, or if T1 is first among tied candidates, T1 is selected.

This selection rule is an application-facing example and may be implemented using any suitable scoring procedure, ordering procedure, comparison procedure, tie-breaking procedure, or selection procedure consistent with the disclosed process.

### 15. How the Selected Transformation is Applied

The software applies the selected transformation to the actual current information structure. T1 modifies E2 so that the proposed action uses a local operation.

The updated element may be:

Element E2′:
text: “The proposed action uses a local operation.”
type: proposed action;
status: active;
attribute: action uses local operation.

The software may also update affected relationships. For example:
R1 may be removed or marked inactive because E2′ is no longer an external cloud API call;
R3 may be removed or marked inactive because E2′ no longer conflicts with the local-only requirement;
R2 may remain active because the local-only requirement still applies to the proposed action.

The modified information structure is then stored as the next structure state.

### 16. How the Process Repeats

The software repeats the process on the modified information structure. It evaluates the incompatibility conditions again.

In the modified structure:
E1 requires local-only operation;
E2′ uses a local operation;
E3 still classifies external cloud API calls as non-local. Because E2′ is not an external cloud API call, C1 is not violated.

The inconsistency measure is:

I(S1)=0.

No active inconsistency record remains for the local-only conflict.

### 17. How Termination is Determined

The software terminates when no further candidate transformation associated with any currently detected inconsistency type and affected locus both satisfies the defined process conditions and reduces the inconsistency measure.

In the example:

I(S1)=0;
no active inconsistency record remains; and
no permitted candidate transformation remains that would further reduce the inconsistency measure.

Therefore, the termination condition is satisfied.

### 18. Output

The software outputs the resulting information structure. The resulting information structure may include:

Element E1:
“The operation must be performed locally.”
type: constraint;
status: active.

Element E2′:
“The proposed action uses a local operation.”
type: proposed action;
status: active.

Element E3:
“External cloud API calls are not local operations.”
type: rule;
status: active.

Relationship R2:
local-only requirement applies to E2′.

Inconsistency measure:

I(S1)=0.

Termination condition:
no permitted reducing candidate transformation remains.

The resulting information structure may be stored, displayed, returned through an API, used by a downstream software module, used to control a subsequent action, or used as an updated reasoning-state structure.

### 19. Mapping to the Disclosed Process Architecture

This embodiment maps to the disclosed process architecture as follows:
receiving input data corresponds to receiving the example input text;
forming the information structure corresponds to creating element records and relationship records;
identifying elements corresponds to classifying segmented input units as constraints, actions, rules, propositions, state descriptors, or other machine-processable elements;
identifying relationships corresponds to creating classification, requirement, support, dependency, contradiction, or incompatibility relationships among elements;
detecting inconsistency corresponds to evaluating incompatibility condition C1 and creating inconsistency record ICR1;
calculating the inconsistency measure corresponds to assigning a weight to ICR1 and computing I(S0)=1;
identifying candidate transformations corresponds to identifying transformations T1 through T5 based on the detected inconsistency type and affected locus;
determining the permitted subset corresponds to testing candidate transformations on copies of the information structure and retaining transformations that satisfy defined process conditions and reduce the inconsistency measure;
selecting and applying a transformation corresponds to selecting T1 and modifying E2 into E2′;
repeating corresponds to evaluating the modified structure S1;
terminating corresponds to determining that no further permitted reducing transformation remains available; and
outputting corresponds to outputting the resulting information structure S1.
generating a state-transition trace record corresponds to recording, for one or more iterations, one or more detected inconsistencies, affected loci, tested candidate transformations, before-and-after inconsistency measures, the permitted subset, the selected transformation, the updated information structure, and termination status.

### Embodiment Summary And Example Support

### Purpose

This section provides non-limiting embodiment examples and clarifies practical implementation directions for the disclosed architecture.

These examples describe information structures, relationship types, attributes,

candidate-transformation classes, and process conditions only. They do not require any particular internal logic by which an implementation may rank, prioritize, preserve, or select one candidate transformation, relationship, element, or output over another.

The embodiments below illustrate how the same process architecture may be implemented in different technical systems. They are not intended to limit the invention to these fields.

### Grounded in the Disclosed Process Architecture

Across the embodiments, the disclosed system can be understood as a processor-implemented or computer-implemented architecture that:
(1) receives or creates a machine-processable information structure;
(2) identifies elements and relationships within that structure;
(3) detects one or more inconsistent states under a defined incompatibility condition;
(4) identifies candidate transformations associated with the detected inconsistency;
(5) determines, under defined process conditions and with respect to an inconsistency measure, a permitted subset of candidate transformations;
(6) selects, from the permitted subset, a candidate transformation that reduces the inconsistency measure;
(7) applies the selected transformation to modify the information structure;
(8) repeats the process on the modified information structure until no further permitted candidate transformation that reduces the inconsistency measure remains available under the defined process conditions; and
(9) outputs the resulting information structure; and
(10) in some embodiments, generates, stores, or outputs a state-transition trace record associated with one or more iterations of the process.

The reason for the abstraction is that the operative mechanism is not tied to one domain. The same process can be embodied in structured reasoning states, knowledge graphs, access-control systems, configuration systems, policy systems, and logical proposition systems.

Other non-limiting implementations may include robotics planning, digital-twin state management, cybersecurity rule correlation, financial-rule reconciliation, medical-device configuration, supply-chain state reconciliation, or other machine-processable domains in which domain objects can be represented as elements, structural links can be represented as relationships, incompatibility conditions can be defined, candidate transformations can be identified, and inconsistency measures can be evaluated.

### Examples of Inconsistency Measures

In non-limiting embodiments, the inconsistency measure may include:
a count of detected incompatibility-condition violations;
a weighted count of incompatible element pairs;
a count of unsatisfied constraints;
a count of mutually exclusive assignments;
a normalized conflict score;
a count of violated graph constraints;
a count of incompatible policy states; or
a count of invalid dependency relationships.

The inconsistency measure may be evaluated before and after a candidate transformation. A candidate transformation may be treated as reducing the inconsistency measure when the value after transformation is lower than the value before transformation under the defined process conditions.

These examples are non-limiting implementation examples and may use any suitable bounded measure, comparison procedure, weighting procedure, normalization procedure, transformation procedure, or software implementation consistent with the disclosed process.

In some embodiments, any of the following example implementations may also generate a state-transition trace record identifying one or more detected inconsistencies, affected loci, candidate transformations, test structures, before-and-after inconsistency measures, permitted-subset determinations, selected transformations, updated structures, and termination status. Such trace records are application-facing and non-limiting and may be implemented using any suitable machine-processable record, data structure, storage format, or software procedure.

### 1. LLM Reasoning-State Inconsistency Resolution

### What it Does

This non-limiting embodiment operates on a structured reasoning state associated with an LLM or AI agent before final output, memory update, tool execution, or action selection.

The embodiment does not replace the LLM. It operates on a machine-processable information structure associated with the LLM's reasoning, tool results, memory facts, constraints, or planned actions.

### Example Input Structure

The input structure may include:
model-generated propositions;
user instructions;
tool outputs;
retrieved facts;
memory entries;
action candidates;
constraints; or
planned operations.

Elements may include propositions, constraints, actions, facts, or state descriptors.

Relationships may include support, contradiction, dependency, prohibition, requirement, or priority/override relationships represented within the information structure.

### Example Detected Inconsistency

Examples of detected inconsistency may include:
the model proposes a cloud API call while the user instruction requires local-only execution;
the model claims a file exists while tool output indicates the file does not exist;
a planned action conflicts with a system constraint;
two memory facts cannot simultaneously be satisfied; or
an intended tool call violates a stated permission condition.

### Example Candidate Transformations

Candidate transformations may include:
removing an unsupported proposition;
modifying a planned action;
substituting a compatible action;
deactivating a conflicting memory assertion;
preserving a constraint identified under the defined process conditions;
rejecting or deferring a tool call; or
marking an unresolved inconsistency for further processing.

### Example Inconsistency Measure

The inconsistency measure may include:
a count of violated user or system constraints;
a weighted count of contradictions between planned actions and tool outputs;
a count of unsupported propositions; or
a normalized score based on incompatible reasoning-state relationships.

### Example Resulting Structure

The resulting structure may be a modified reasoning-state structure in which no further permitted candidate transformation that reduces the inconsistency measure remains available under the defined process conditions.

In one non-limiting implementation corresponding to the LLM reasoning-state embodiment, the information structure is a structured reasoning-state structure associated with a local-only reasoning state, and the state-transition trace record is generated as a structured runtime trace. The information structure may include element records representing a user instruction or constraint, a model-proposed action, tool output, a local-only rule, and a local candidate action. Relationship records may represent that the user instruction prohibits the model-proposed action, that the tool output supports the local candidate action, that the local-only rule applies to the user instruction, and that the local candidate action substitutes for the model-proposed action.

In that representative implementation, the detected inconsistency may be a local-only violation in which a proposed external cloud API action conflicts with an active local-only constraint. Candidate transformations may include modifying the proposed action to use local operations, substituting the proposed action with the local candidate action, deactivating the proposed external action, or marking the proposed external action as non-permitted. Candidate-test data may identify, for a tested transformation, a post-transformation inconsistency measure, a reduction value, association with an active inconsistency record, valid-structure status, process-condition satisfaction, reduction status, permitted status, exclusion reasons, and a test information structure.

In one representative trace, substituting the proposed external cloud API action with a local candidate action reduces the inconsistency measure from one to zero, is included in the permitted subset, and is selected as the applied transformation. The updated reasoning-state information structure includes an active local action and no active external cloud API action. A subsequent trace state identifies no active inconsistency records, an inconsistency measure of zero, no remaining candidate transformations, an empty permitted subset, and a resolved termination status.

This implementation is non-limiting. A more detailed worked version of this local-only reasoning-state trace is provided below in Example 5.

### Why it Matters

This embodiment illustrates the present invention's relevance to inconsistent reasoning, invalid plans, tool-use conflicts, memory contradictions, and unreliable agent behavior. This embodiment, however, should be treated as one non-limiting example.

### 2. Knowledge-Graph Consistency Repair

### What it Does

This non-limiting embodiment repairs inconsistencies in enterprise, AI-memory, retrieval, analytic, or operational knowledge graphs.

### Example Input Structure

The input structure may include:
entity nodes;
relationship edges;
classification attributes;
timestamps;
confidence values;
source identifiers; or
domain/range constraints.

Relationships may include “is-a,” “part-of,” “owns,” “depends-on,” “located-at,” “same-as,” “conflicts-with,” or “derived-from.”

### Example Detected Inconsistency

Examples of detected inconsistency may include:
one entity is classified both as “active vendor” and “terminated vendor”;
two entity nodes are merged despite incompatible identifiers;
a relationship violates a domain/range constraint;
two dates or status values cannot simultaneously be satisfied; or
an entity has mutually exclusive classifications.

### Example Candidate Transformations

Candidate transformations may include:
removing an incompatible edge;
splitting an incorrectly merged node;
merging duplicate nodes;
deactivating an unsupported assertion;
substituting a corrected classification;
modifying a confidence attribute represented in the information structure; or
preserving a relationship identified under the defined process conditions.

### Example Inconsistency Measure

The inconsistency measure may include:
a count of violated graph constraints;
a weighted count of incompatible classifications;
a count of conflicting entity-identity assignments; or
a normalized score based on incompatible edge states.

### Example Resulting Structure

The resulting structure may be a knowledge graph in which incompatible classifications, invalid edges, or unsatisfied relationship constraints may be reduced until no further permitted reducing transformation remains available under the defined process conditions.

In one non-limiting implementation corresponding to a knowledge-graph information structure, the state-transition trace record may be generated as a structured runtime trace. The field names, identifiers, labels, and values described in this paragraph are representative of that implementation and do not require other embodiments to use the same names, labels, values, ordering, schema, runtime environment, or storage format.

The initial information structure may include an entity element representing a device, status-attribute elements representing different device-status values, source-record elements supporting the respective status values, and a constraint element specifying that the device may not simultaneously have active and decommissioned status. The relationship records may include source-support relationships, status-description relationships between the status attributes and the device entity, and an applies-to relationship from the status constraint to the device.

In the representative trace, candidate transformations modify the active status of one of the conflicting attribute elements while preserving the machine-processable graph structure. The resulting trace state includes no active inconsistency records, an inconsistency measure of zero, an empty candidate-transformation set, an empty permitted subset, and a resolved termination status.

This representative trace is non-limiting and illustrates how the disclosed process may operate over entity nodes, attributes, source records, support relationships, descriptive relationships, and graph-level incompatibility conditions.

### Why it Matters

This embodiment illustrates the present invention's relevance to enterprise data quality, retrieval-augmented generation, AI memory, entity resolution, search, analytics, and compliance graphs.

### 3. Access-Control Entitlement Cleanup

### What it Does

This non-limiting embodiment resolves inconsistent user-role-permission states in identity and access-management systems.

### Example Input Structure

The input structure may include:
users;
roles;
groups;
permissions;
resources;
grants;
denials;
inherited permissions; or
policy constraints.

Relationships may include membership, assignment, inheritance, allow, deny, dependency, exception, or separation-of-duty relationships.

### Example Detected Inconsistency

Examples of detected inconsistency may include:
a user has both allow and deny permissions for the same resource;
a user has mutually exclusive roles;
stale access remains for a terminated user;
inherited permissions violate a direct restriction; or
a separation-of-duty rule is violated.

### Example Candidate Transformations

Candidate transformations may include:
removing stale access;
deactivating a conflicting role;
narrowing a permission;
breaking an inherited grant;
preserving a deny relationship identified under defined process conditions;
quarantining an entitlement for review; or
substituting a compatible role or permission.

### Example Inconsistency Measure

The inconsistency measure may include:
a count of violated entitlement constraints;
a weighted count of toxic role combinations;
a count of conflicting allow/deny relationships; or
a normalized access-conflict score.

### Example Resulting Structure

The resulting structure may be a modified entitlement graph in which access conflicts have been reduced and no further permitted candidate transformation that reduces the inconsistency measure remains available under the defined process conditions.

### Why it Matters

This embodiment illustrates the present invention's relevance to identity governance, zero-trust architecture, audit readiness, least-privilege enforcement, separation-of-duty controls, and insider-risk reduction.

### 4. Configuration/Constraint State Resolution

### What it Does

This non-limiting embodiment resolves incompatible technical configurations in software, cloud, hardware, deployment, or infrastructure systems.

### Example Input Structure

The input structure may include:
components;
versions;
dependencies;
resources;
regions;
devices;
runtime settings;
deployment conditions; or
hardware profiles.

Relationships may include dependency, incompatibility, requirement, version constraint, resource allocation, placement, or availability relationships.

### Example Detected Inconsistency

Examples of detected inconsistency may include:
incompatible package versions;
insufficient hardware capabilities;
region-policy conflicts;
resource-allocation contradictions;
port collisions;
impossible dependency requirements; or
deployment conditions that cannot simultaneously be satisfied.

### Example Candidate Transformations

Candidate transformations may include:
changing a version;
substituting a dependency;
moving a service to a compatible node;
modifying a resource allocation;
selecting a compatible hardware profile;
removing an invalid setting; or
splitting a deployment.

### Example Inconsistency Measure

The inconsistency measure may include:
a count of unsatisfied dependency constraints;
a weighted count of incompatible configuration relationships;
a count of invalid deployment states; or
a normalized configuration-conflict score.

### Example Resulting Structure

The resulting structure may be a modified configuration structure suitable for deployment, validation, enforcement, or continued machine control, where no further permitted reducing transformation remains available.

In one non-limiting implementation corresponding to a relationship-level configuration or dependency inconsistency, the state-transition trace record may be generated as a structured runtime trace. The field names, identifiers, labels, and values described in this paragraph are representative of that implementation and do not require other embodiments to use the same names, labels, values, ordering, schema, runtime environment, or storage format.

The initial information structure may include service elements representing a first service, a prohibited dependency service, and a substitute dependency service. The information structure may also include a dependency-constraint element specifying that the first service may not depend on the prohibited dependency service, and a substitute-dependency element specifying that the first service may depend on the substitute dependency service.

The relationship records may include an active invalid-dependency relationship from the first service to the prohibited dependency service, an applies-to relationship from the dependency constraint to the prohibited dependency service, and a substitute-dependency relationship identifying the substitute dependency service. The invalid-dependency relationship may include attributes indicating that the dependency is active and prohibited.

After application of the selected transformation, the invalid-dependency relationship may be changed to an inactive relationship state while the constraint relationship and substitute-dependency relationship may remain represented in the information structure. The resolved trace state may identify no active inconsistency records, an inconsistency measure of zero, no remaining candidate transformations, an empty permitted subset, and a resolved termination status.

This representative trace is non-limiting and illustrates that the disclosed process may operate not only on elements, but also on relationship status, relationship attributes, dependency validity, and substitute relationship structures within a machine-processable information structure.

### Why it Matters

This embodiment illustrates the present invention's relevance to DevOps, CI/CD, infrastructure-as-code, cloud deployment, dependency resolution, hardware setup, and automated deployment validation.

### 5. Configuration-Policy Conflict Resolution

### What it Does

This non-limiting embodiment reconciles operational states with business, security, legal, or compliance policies.

### Example Input Structure

The input structure may include:
policies;
workflow states;
permitted actions;
prohibited actions;
approval requirements;
audit constraints;
regulatory requirements; or
configuration states.

Relationships may include allows, prohibits, requires, overrides, depends-on, conflicts-with, or requires-approval relationships.

### Example Detected Inconsistency

Examples of detected inconsistency may include:
a workflow allows an action that a compliance policy prohibits;
a system disables encryption where policy requires encryption;
a transaction is allowed by one rule and blocked by another;
an operational state violates a security constraint; or
a configuration conflicts with a regulatory requirement.

### Example Candidate Transformations

Candidate transformations may include:
blocking an action;
requiring approval;
substituting a compliant workflow;
modifying a configuration;
escalating to review;
preserving a policy identified under defined process conditions; or
marking an action as non-permitted under the defined process conditions.

### Example Inconsistency Measure

The inconsistency measure may include:
a count of violated policy constraints;
a weighted count of prohibited operational states;
a count of unresolved allow/deny conflicts; or
a normalized policy-conflict score.

### Example Resulting Structure

The resulting structure may be a modified policy-governed structure in which policy conflicts have been reduced under the defined process conditions and no further permitted reducing transformation remains available.

### Why it Matters

This embodiment illustrates the present invention's relevance to healthcare, finance, cybersecurity governance, enterprise compliance, audit systems, and policy automation.

### 6. Logical Proposition Conflict Resolution

### What it Does

This non-limiting embodiment resolves contradictions in symbolic propositions, rule-based reasoning states, or structured logical assertions.

### Example Input Structure

The input structure may include:
propositions;
rules;
implications;
negations;
constraints;
assertions; or
support relationships.

Relationships may include contradiction, implication, dependency, support, mutual exclusion, or requirement relationships.

### Example Detected Inconsistency

Examples of detected inconsistency may include:
both A and NOT A are present;
B implies C, B is present, and NOT C is present;
two propositions are mutually exclusive;
a rule conclusion conflicts with a constraint; or
a proposition violates a defined incompatibility condition.

### Example Candidate Transformations

Candidate transformations may include:
removing a proposition;
modifying a proposition;
substituting a weaker proposition;
deactivating a proposition;
preserving a relationship identified under the defined process conditions; or
marking a contradiction unresolved when no permitted reducing transformation exists.

### Example Inconsistency Measure

The inconsistency measure may include:
a count of direct contradictions;
a count of violated implication constraints;
a weighted count of mutually exclusive propositions; or
a normalized contradiction score over the proposition set.

### Example Resulting Structure

The resulting structure may be a proposition set in which contradictions may be reduced and no further permitted candidate transformation that reduces the inconsistency measure remains available under the defined process conditions.

In one non-limiting implementation corresponding to a logical-proposition information structure, the state-transition trace record may be generated as a structured runtime trace. The field names, identifiers, labels, and values described in this paragraph are representative of that implementation and do not require other embodiments to use the same names, labels, values, ordering, schema, runtime environment, or storage format.

The initial information structure may include a first proposition element representing a proposition, a second proposition element representing a negation of that proposition, a third proposition element, and a constraint element specifying that a proposition and its negation cannot both be active. The relationship records may include a direct-contradiction relationship between the proposition and its negation, an applies-to relationship from the direct-contradiction condition to the affected proposition pair, and a support relationship in which one proposition may support another proposition in the example structure.

In the representative trace, the conflicting negation proposition may be deactivated in the resulting information structure while the valid proposition and support structure may be retained. The resolved trace state may include no active inconsistency records, an inconsistency measure of zero, an empty candidate-transformation set, an empty permitted subset, and a resolved termination status.

This representative trace is non-limiting and illustrates baseline operation of the disclosed process over symbolic propositions and direct contradiction relationships.

### Why it Matters

This embodiment supports structured reasoning states, rule engines, and knowledge-graph repair.

### Summary

The aforementioned embodiments are non-limiting examples of the same process architecture operating in different technical environments.

Across the examples, the common structure is:
machine-processable information structure;
elements;
relationships;
defined incompatibility condition;
candidate transformations;
permitted subset under defined process conditions;
inconsistency measure;
selected candidate transformation that reduces the inconsistency measure;
iterative modification;
termination condition; and
resulting information structure.

The examples discussed above, including LLM reasoning-state, support-system/user-context, knowledge-graph, access-control, configuration or constraint-state, relationship-level dependency, configuration-policy, policy-rule, and logical-proposition embodiments, are intended to illustrate non-limiting embodiments of the disclosed process architecture.

### Additional Application Facing Worked Examples

The following examples are non-limiting representative implementations of the disclosed inconsistency-resolution process. Each example illustrates an information structure comprising elements and relationships, a defined incompatibility condition, candidate transformations, determination of a permitted subset under defined process conditions and with respect to an inconsistency measure, selection and application of a permitted candidate transformation that reduces the inconsistency measure, and production of a resulting information structure upon satisfaction of a termination condition.

### Example 1—Access-Control Entitlement Conflict

### 1. Input Structure

In one non-limiting example, the information structure is an access-control structure comprising users, roles, permissions, resources, and policy constraints.

### 2. Elements

E1=User U1
E2=Role R_admin
E3=Role R_auditor
E4=Permission P_modify_records
E5=Permission P_approve_audit
E6=Constraint C_sod: a user may not simultaneously hold R_admin and R_auditor

### 3. Relationships

R1=U1 assigned_to R_admin
R2=U1 assigned_to R_auditor
R3=R_admin grants P_modify_records
R4=R_auditor grants P_approve_audit
R5=C_sod applies_to {R_admin, R_auditor}

### 4. Defined Incompatibility Condition

C1 is violated when the same user is assigned both R_admin and R_auditor.

### 5. Detected Inconsistency

At S_0, user U1 is assigned both R_admin and R_auditor.

l1={U1, R_admin, R_auditor, C_sod}

A_0={a_1,l1}

### 6. Inconsistency Measure Before Transformation

In this example, the inconsistency measure is a count of active incompatibility-condition violations. I(S_0)=1

### 7. Candidate Transformations

T1=remove assignment U1→R_admin
T2=remove assignment U1→R_auditor
T3=substitute R_auditor with R_viewer
T4=mark assignment U1→R_auditor as non-permitted

### 8. Permitted-Subset Determination

Each candidate is applied to a test structure S_0\hat{ }T. A candidate is included in P_0 only if it:
is associated with the detected separation-of-duty inconsistency;
produces a valid access-control structure;
satisfies the defined process conditions; and
reduces I(S_0).

In this example:
T1 is excluded because U1 is required to retain administrative access.
T2 is permitted because it removes the conflicting auditor assignment.
T3 is permitted because it substitutes a non-conflicting role.
T4 is permitted because it prevents the conflicting assignment from remaining active. Thus:

P_0={T2, T3, T4}

### 9. Selected Permitted Transformation

Using an application-facing deterministic selection rule, the processor selects:

T*_0=T2

### 10. Modified Structure

The processor removes:
U1 assigned_to R_auditor

The modified structure S_1 retains:
U1 assigned_to R_admin
R_admin grants P_modify_records

### 11. Inconsistency Measure After Transformation

A_1=∅

I(S_1)=0

### 12. Termination Test

Because no active inconsistency remains, the process terminates.

S_final=S_1

A state-transition trace record for this example may identify S_0, A_0, I(S_0), the candidate transformations, the permitted subset, T*_0, S_1, I(S_1), and the termination status.

### 13. Resulting Information Structure

The resulting access-control structure maintains administrative access for U1 and removes the separation-of-duty violation.

### 14. Boundary Statement

This example is application-facing and non-limiting and may be implemented using any suitable machine-processable representation, comparison procedure, transformation procedure, selection procedure, storage format, or software implementation consistent with the disclosed process.

### Example 2—Cloud Deployment Dependency Conflict

### 1. Input Structure

In one non-limiting example, the information structure is a cloud deployment structure comprising services, regions, dependencies, deployment constraints, and resource assignments.

### 2. Elements

E1=Service S_web
E2=Service S_database
E3=Region R_us_east
E4=Region R_eu_west
E5=Constraint C_colocation: S_web and S_database must be deployed in the same region
E6=Deployment assignment A1: S_web deployed in R_us_east
E7=Deployment assignment A2: S_database deployed in R_eu_west

### 3. Relationships

R1=S_web depends_on S_database
R2=S_web assigned_to R_us_east
R3=S_database assigned_to R_eu_west
R4=C_colocation applies_to {S_web, S_database}

### 4. Defined Incompatibility Condition

C1 is violated when two services subject to C_colocation are assigned to different deployment regions.

### 5. Detected Inconsistency

At S_0, S_web is in R_us_east and S_database is in R_eu_west, even though the colocation constraint requires them to be in the same region.

l1={S_web, S_database, R_us_east, R_eu_west, C_colocation}

A_0={a_1,l1}

### 6. Inconsistency Measure Before Transformation

I(S_0)=1

### 7. Candidate Transformations

T1=reassign S_database from R_eu_west to R_us_east
T2=reassign S_web from R_us_east to R_eu_west
T3=substitute C_colocation with a cross-region-compatible dependency rule
T4=mark deployment assignment A2 as non-permitted

### 8. Permitted-Subset Determination

Each candidate is applied to a test structure. In this example:
T1 reduces I(S_0) from 1 to 0 and satisfies resource-availability conditions.
T2 is excluded because R_eu_west lacks required web-service capacity.
T3 is excluded because the constraint is mandatory for this deployment.
T4 is permitted if the process conditions allow invalid assignment removal.

Thus:

P_0={T1, T4}

### 9. Selected Permitted Transformation

Using an application-facing selection rule, the processor selects:

T*_0=T1
because it produces a valid deployment structure and reduces the inconsistency measure to zero.

### 10. Modified Structure

S_database is reassigned:
S_database assigned_to R_us_east

### 11. Inconsistency Measure After Transformation

A_1=∅

I(S_1)=0

### 12. Termination Test

No further permitted candidate transformation that reduces the inconsistency measure remains available.

S_final=S_1

A state-transition trace record for this example may identify S_0, A_0, I(S_0), the candidate transformations, the permitted subset, T*_0, S_1, I(S_1), and the termination status.

### 13. Resulting Information Structure

The resulting deployment structure places both dependent services in R_us_east and satisfies the colocation constraint.

### 14. Boundary Statement

This example is application-facing and non-limiting and may be implemented using any suitable machine-processable representation, comparison procedure, transformation procedure, selection procedure, storage format, or software implementation consistent with the disclosed process.

### Example 3-Knowledge Graph Contradiction

### 1. Input Structure

In one non-limiting example, the information structure is a knowledge graph comprising entity nodes, attribute nodes, relationship edges, source records, and graph constraints.

### 2. Elements

E1=Entity Node: Device D1
E2=Attribute: D1 status=active
E3=Attribute: D1 status=decommissioned
E4=Source Record SR_A supporting active status
E5=Source Record SR_B supporting decommissioned status
E6=Constraint C_status: a device may not simultaneously have active and decommissioned status

### 3. Relationships

R1=SR_A supports E2
R2=SR_B supports E3
R3=E2 describes D1
R4=E3 describes D1
R5=C_status applies_to {E2, E3}

### 4. Defined Incompatibility Condition

C1 is violated when the same entity has both active and decommissioned status.

### 5. Detected Inconsistency

At S_0, D1 has incompatible status attributes.

l1={D1, E2, E3, C_status}

A_0={a_1,l1}

### 6. Inconsistency Measure Before Transformation

In this example, the inconsistency measure is a count of incompatible attribute pairs.

I(S_0)=1

### 7. Candidate Transformations

T1=deactivate E2
T2=deactivate E3
T3=substitute E2 with D1 status=pending review
T4=substitute E3 with D1 status=pending review
T5=quarantine both status attributes for downstream review

### 8. Permitted-Subset Determination

Each transformation is applied to a test graph. In this example:
T1 is excluded because SR_A has a newer timestamp and satisfies a defined source-condition for the embodiment.
T2 is permitted because it removes the conflicting older status attribute.
T3 is excluded because it removes a current operational status required by the process conditions.
T4 is permitted because it replaces the conflicting older status with a non-conflicting review state.
T5 is permitted if the process conditions allow unresolved but inactive quarantine.

Thus:

P_0={T2, T4, T5}

### 9. Selected Permitted Transformation

Using a deterministic selection rule or predefined ordering, the processor selects:

T*_0=T2

### 10. Modified Structure

The graph is updated so that:
E3=D1 status=decommissioned
is marked inactive or removed from the active graph.

### 11. Inconsistency Measure After Transformation

A_1=∅

I(S_1)=0

### 12. Termination Test

No active incompatible status pair remains.

S_final=S_1

A state-transition trace record for this example may identify S_0, A_0, I(S_0), the candidate transformations, the permitted subset, T*_0, S_1, I(S_1), and the termination status.

### 13. Resulting Information Structure

The resulting knowledge graph retains a single active status for D1 and preserves the decommissioned status as inactive, removed, or otherwise non-active depending on the implementation.

### 14. Boundary Statement

This example is application-facing and non-limiting and may be implemented using any suitable machine-processable representation, comparison procedure, transformation procedure, selection procedure, storage format, or software implementation consistent with the disclosed process.

### Example 4—Policy-Rule Conflict

### 1. Input Structure

In one non-limiting example, the information structure is a policy-rule structure comprising governed entities, rules, permissions, prohibitions, conditions, and enforcement states.

### 2. Elements

E1=Resource R_financial_report
E2=User group G_contractors
E3=Rule P_allow: G_contractors may access R_financial_report
E4=Rule P_deny: G_contractors may not access R_financial_report
E5=Constraint C_no_conflicting_policy: a policy set may not contain both allow and deny rules for the same subject-resource pair under the same condition

### 3. Relationships

R1=P_allow applies_to {G_contractors, R_financial_report}
R2=P_deny applies_to {G_contractors, R_financial_report}
R3=C_no_conflicting_policy applies_to {P_allow, P_deny}

### 4. Defined Incompatibility Condition

C1 is violated when an allow rule and deny rule govern the same subject-resource pair under the same condition.

### 5. Detected Inconsistency

At S_0, both P_allow and P_deny apply to the same group and resource.

l1={G_contractors, R_financial_report, P_allow, P_deny, C_no_conflicting_policy}

A_0={a_1,l1}

### 6. Inconsistency Measure Before Transformation

I(S_0)=1

### 7. Candidate Transformations

T1=deactivate P_allow
T2=deactivate P_deny
T3=modify P_allow to apply only to employees
T4=modify P_deny to apply only outside approved time windows
T5=substitute P_allow with a conditional allow requiring supervisor approval

### 8. Permitted-Subset Determination

Each candidate is evaluated under the defined process conditions. In this example:
T1 is permitted because it removes the conflicting allow rule.
T2 is excluded because the deny rule is mandatory under a higher-level compliance constraint.
T3 is permitted because it removes G_contractors from the allow rule.
T4 is excluded because it still conflicts during overlapping time windows.
T5 is permitted if the supervisor-approval condition no longer conflicts with P_deny under the defined process conditions.

Thus:

P_0={T1, T3, T5}

### 9. Selected Permitted Transformation

Using an application-facing selection rule, the processor selects:

T*_0=T3
because it preserves an allow rule for a non-conflicting subject class while reducing the inconsistency measure.

### 10. Modified Structure

P_allow is modified from:
G_contractors may access R_financial_report to:
G_employees may access R_financial_report
or another non-conflicting subject class under the defined process conditions.

### 11. Inconsistency Measure After Transformation

A_1=∅

I(S_1)=0

### 12. Termination Test

The processor evaluates the modified policy structure and determines no further permitted reducing transformation remains available.

S_final=S_1

A state-transition trace record for this example may identify S_0, A_0, I(S_0), the candidate transformations, the permitted subset, T*_0, S_1, I(S_1), and the termination status.

### 13. Resulting Information Structure

The resulting policy structure removes the conflicting allow/deny state for contractors and remains suitable for enforcement.

In one non-limiting implementation corresponding to a policy-rule conflict, the state-transition trace record may be generated as a structured runtime trace. The field names, identifiers, labels, and values described in this paragraph are representative of that implementation and do not require other embodiments to use the same names, labels, values, ordering, schema, runtime environment, or storage format.

The initial information structure may include a group element, an allow-rule element, a deny-rule element, and a constraint element specifying that conflicting allow and deny rules for the same subject-resource pair are not permitted. The relationship records may include an allows relationship from the allow rule to the group, a denies relationship from the deny rule to the group, and an applies-to relationship from the no-conflict constraint to the policy rules. The active inconsistency may correspond to an allow/deny conflict over the same subject-resource pair.

In the resolved trace state, the active inconsistency records may be empty, the inconsistency measure may be zero, the candidate-transformation set and permitted subset may be empty, and the termination status may be resolved. The representative trace demonstrates that policy-rule conflicts may be represented as machine-processable elements and relationships and resolved by applying candidate transformations under defined process conditions until no active allow/deny inconsistency remains or no further permitted reducing transformation is available.

### 14. Boundary Statement

This example is application-facing and non-limiting and may be implemented using any suitable machine-processable representation, comparison procedure, transformation procedure, selection procedure, storage format, or software implementation consistent with the disclosed process.

### Example 5—AI Tool-Output Contradiction/Structured Reasoning-State Inconsistency

### 1. Input Structure

In one non-limiting example, the information structure is a structured reasoning-state structure associated with an AI agent, including user instructions, model-generated propositions, tool outputs, candidate actions, and constraints.

### 2. Elements

E1=User constraint: perform only local file operations
E2=Model proposed action: call external cloud API to inspect file metadata
E3=Tool output: requested file exists locally
E4=Constraint C_local_only: external cloud API calls are not permitted when local-only operation is required
E5=Candidate action A_local: inspect local file metadata using local operation

### 3. Relationships

R1=E1 prohibits E2
R2=E3 supports A_local
R3=E4 applies_to {E1, E2}
R4=E5 substitutes_for E2

### 4. Defined Incompatibility Condition

C1 is violated when a proposed action requires an external cloud API call while a local-only operation constraint is active.

### 5. Detected Inconsistency

At S_0, the proposed cloud API action conflicts with the local-only constraint.

l1={E1, E2, E4}

A_0={a_1,l1}

### 6. Inconsistency Measure Before Transformation

In this example, the inconsistency measure is a count of violated user or system constraints.

I(S_0)=1

### 7. Candidate Transformations

T1=modify E2 so the proposed action uses a local operation
T2=substitute E2 with E5
T3=deactivate E2
T4=mark E2 as non-permitted
T5=defer E2 for review

### 8. Permitted-Subset Determination

Each candidate is applied to a test reasoning-state structure. In this example:
T1 is permitted because it changes the action to a local operation and reduces I(S_0) to 0.
T2 is permitted because it substitutes a compatible local action and reduces I(S_0) to 0.
T3 is permitted if deactivation of the proposed action satisfies the process conditions.
T4 is permitted because it marks the cloud API action as non-permitted.
T5 is excluded if deferral does not reduce the inconsistency measure.

Thus:

P_0={T1, T2, T3, T4}

### 9. Selected Permitted Transformation

Using a deterministic selection rule or predefined ordering, the processor selects:

T*_0=T2

### 10. Modified Structure

The reasoning-state structure substitutes:
external cloud API inspection with:
local file metadata inspection

### 11. Inconsistency Measure After Transformation

A_1=∅

I(S_1)=0

### 12. Termination Test

No active local-only violation remains, and no further permitted candidate transformation that reduces the inconsistency measure remains available.

S_final=S_1

A state-transition trace record for this example may identify S_0, A_0, I(S_0), the candidate transformations, the permitted subset, T*_0, S_1, I(S_1), and the termination status.

### 13. Resulting Information Structure

The resulting reasoning-state structure contains a permitted local operation and excludes the conflicting external cloud API action from the active action set.

In one non-limiting implementation corresponding to this example, the state-transition trace record may be generated as a structured runtime trace for a local-only reasoning-state profile. The field names, identifiers, labels, and values described in this paragraph are representative of that implementation and do not require other embodiments to use the same names, labels, values, ordering, schema, runtime environment, or storage format.

At an initial iteration, the information structure may include five active element records. A user-constraint element may represent a requirement to use only local file operations and not call external APIs. A model-proposed-action element may represent a proposed external cloud API call. A tool-output element may represent that the requested file or task context is available locally. A local-only-rule element may represent that external cloud API calls are not permitted when local-only operation is required. A local-candidate-action element may represent inspection or processing using a local operation.

The trace may include relationship records representing that the user constraint prohibits the model-proposed external cloud API action, that the tool-output element supports the local candidate action, that the local-only rule applies to the user constraint, and that the local candidate action substitutes for the proposed external action.

The active inconsistency record may identify a local-only violation, an affected locus containing the user constraint, the model-proposed action, and the local-only rule, and a weight of one. The inconsistency measure before transformation may be one. Candidate transformations may include modifying the model action to use local operations, substituting the proposed action with the local candidate action, deactivating the proposed external action, and marking the proposed external action as non-permitted.

Candidate-test data for the substitution transformation may indicate a post-transformation inconsistency measure of zero, a reduction value of one, association with the active inconsistency record, valid-structure status, process-condition satisfaction, reduction status, permitted status, and no exclusion reason. The selected transformation may substitute the proposed external cloud API action with the local candidate action. After application of the selected transformation, the updated information structure may include an active local action and no active external cloud API action. A subsequent trace state may identify no active inconsistency records, an inconsistency measure of zero, no remaining candidate transformations, an empty permitted subset, and a resolved termination status.

This representative trace demonstrates that the disclosed process may operate on a structured reasoning-state information structure associated with an artificial-intelligence system while preserving user constraints, tool-output support, candidate-action substitution, permitted-subset determination, and traceable termination.

### 14. Boundary Statement

This example is application-facing and non-limiting and may be implemented using any suitable machine-processable representation, comparison procedure, transformation procedure, selection procedure, storage format, or software implementation consistent with the disclosed process.

### Formula-Derived Claim Support and Non-Limitation

The following dependent claim concepts may correspond to particular non-limiting embodiments of the disclosed process. Unless expressly recited in an independent claim, formula-specific features such as raw inconsistency measures, normalized inconsistency measures, reference values, reduction values, active inconsistency-record sets, candidate-test matrices, trace-record fields, and particular test conditions are not intended to limit embodiments that perform the broader disclosed process using other bounded inconsistency measures, candidate-evaluation procedures, representation forms, or machine-processable structures.

### Claim Narratives

(1) In some embodiments, the present systems and methods for resolving inconsistency within an information structure may be implemented using a computing device, processor, processing circuit, server, distributed processing system, mobile device, or other processor-executable environment. In some embodiments, methods for resolving inconsistency within an information structure may comprise the following steps: (a) a computing device or processor may receive or may generate a machine-processable information structure comprising at least a plurality of elements. In some cases, the received or generated information structure may comprise a plurality of elements and one or more relationships may be determined or generated later; in other cases, the received or generated information structure may comprise at least one relationship as well. In cases in which the received or generated information structure does not comprise at least one relationship, the computing device or processor may (b) identify or generate one or more relationships, in some cases based at least in part on the plurality of elements. (c) The computing device or processor may detect at least one inconsistency within the information structure based on a defined incompatibility condition. In some cases, the incompatibility condition may be stored in a local memory of the computing device; in other cases, the incompatibility condition may be stored in the memory of a server, database, or another computing device accessible to the computing device or processor operating the method. (d) The computing device or processor may generate or determine a subset of candidate transformations to address the inconsistency. In some cases, the subset of candidate transformations may be based at least in part on an inconsistency measure, also referred to as an inconsistency measurement, and a plurality of candidate transformations. (e) The computing device or processor may select from the subset of candidate transformations at least one candidate transformation. In some cases, the selected at least one candidate transformation may be selected based at least in part on the inconsistency measure. (f) The selected candidate transformation may be applied to the information structure in order to modify or address the inconsistency within the information structure. Applying the selected candidate transformation to the information structure may result in the modified or resulting information structure being created. (g) In some cases, steps (c)-(f), i.e., detecting an inconsistency, determining a subset of candidate transformations, selecting a candidate transformation, and applying the candidate transformation, may be performed iteratively until a termination condition is satisfied. In some cases, the termination condition may correspond to a state in which no further permitted candidate transformation that reduces the inconsistency measure remains available under the defined process conditions. (h) The computing device or processor may additionally output the resulting information structure. (2) In some cases, the present systems and methods for resolving inconsistency within an information structure may provide a memory storing a machine-processable information structure, and a processor. In such embodiments, the processor may be configured to (i) detect at least one inconsistency based on a defined incompatibility condition. The incompatibility condition may be stored in the memory; in other cases, it may be stored remotely, meaning in another computing device, database, or server accessible to the system. In such cases, the present system may communicate via a network to receive or access the incompatibility condition. (ii) The processor may be configured to determine a subset of candidate transformations which may be used to modify the information structure in order to resolve the inconsistency. In some cases, the subset of candidate transformations may be determined or may be based at least in part on a plurality of candidate transformations and/or an inconsistency measure. (iii) The processor may be configured to select a candidate transformation from the subset of permitted candidate transformations. In some cases, the selection of the candidate transformation to be applied to the information structure may be based upon an inconsistency measurement of the information structure. (iv) The processor may be configured to apply the selected candidate transformation to the information structure to resolve or reduce the detected inconsistency. (v) In some cases, the processor may be configured to perform steps (i)-(iv), i.e., inconsistency detection, determination of a permitted subset, transformation selection, and transformation application, iteratively until a termination condition is satisfied. In some cases, the termination condition may correspond to a state in which no further permitted candidate transformation that reduces an inconsistency measure remains available. (vi) The processor may be configured to output the resulting information structure. Outputting the resulting information structure may comprise displaying it to a user of a computing device, e.g., via a user interface such as a screen or visual display; storing the resulting information structure in memory; storing it in the memory of another computing device or server; returning it through an application programming interface; supplying it to a downstream software module; or otherwise making it available as machine-processable output.
(5) In some cases, the present systems and methods for resolving inconsistency within an information structure may provide for a processor-implemented or computer-implemented method for generating a traceable inconsistency-resolution record. The steps of this may be as follows: (a) A machine-processable information structure comprising elements and relationships may be received and/or accessed by a computing device or processor. In some cases, this information structure may be received having elements and relationships; in other cases, input data may be received and may then be converted by the computing device or processor into an information structure having elements and relationships. (b) One or more inconsistencies within the information structure may be detected based at least in part on a defined incompatibility condition. In some cases, the incompatibility condition may be stored in a local memory; in other cases, it may be stored remotely, e.g., on a database or server. The incompatibility condition may relate to one or more elements, relationships, attributes, constraints, state descriptors, or substructures of the information structure. (c) An inconsistency measure, also referred to as an inconsistency measurement, may be calculated. The inconsistency measure may be based on one or both of the information structure and the detected inconsistencies. (d) A plurality of candidate transformations may be identified. In some cases, the plurality of candidate transformations may be identified using the inconsistency measurement. (e) Simulated post-transformation inconsistency measurements may be calculated for some or all of the plurality of candidate transformations. This may be done in order to compare how each of the plurality of candidate transformations may impact the inconsistency measurement for the information structure as a whole if implemented. (f) A permitted subset of candidate transformations may be determined. In some cases, the determination of the permitted subset may be based at least in part on an inconsistency measure of the information structure. (g) A candidate transformation may be selected from the permitted subset of candidate transformations and (h) applied to modify the information structure. (i) In some cases, the steps of (b)-(h), i.e., inconsistency detection, inconsistency measure calculation, identifying a plurality of candidate transformations, calculating post-candidate-transformation inconsistency measures, determining a permitted subset of candidate transformations, selecting a candidate transformation, and applying the candidate transformation, may be performed iteratively until a termination condition is satisfied. The termination condition may correspond to a state in which no further permitted candidate transformation that reduces the inconsistency measure remains available. (j) In some cases, a state-transition trace record may be generated. A state-transition trace record may be based at least in part on some or all of: (i) the detected inconsistency, (ii) the inconsistency measure before applying the selected candidate transformation, (iii) at least one tested candidate transformation, (iv) a post-transformation inconsistency measure associated with the tested candidate transformation, (v) a reduction value associated with the tested candidate transformation, (vi) the permitted subset, (vii) the selected candidate transformation, (viii) the modified information structure, and (ix) a termination status. (k) The modified information structure may be output alongside the state-transition trace record.

In some examples, some or all of the above instructions, worked examples, formulas, or pseudocode may be used to generate, configure, test, or implement computer code for performing one or more steps of the methods disclosed herein. In some cases, the computer code may be generated manually, by a software-development environment, by a code-generation system, or by a large language model configured for software generation. In some examples, the generated computer code may be incorporated into a software module, software wrapper, application programming interface, local runtime, server-side runtime, or artificial-intelligence system wrapper that operates on a machine-processable information structure according to the disclosed process. In some implementations, such a wrapper may act as an intermediary between a user, a software system, and an underlying program, including but not limited to an LLM.

In such implementations, the generated code, wrapper, or software module remains an implementation mechanism for carrying out the disclosed information-structure process. The invention is not limited to use of a large language model to generate code, is not limited to prompt-based control of an artificial-intelligence model, and does not require any particular model, code-generation tool, programming language, runtime environment, prompt format, or internal reasoning path unless expressly recited in a claim.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If presented, claims directed to a method and/or process should not be limited to performance of their steps in the order written, and a person of ordinary skill in the art can appreciate that the sequence of steps may be varied while remaining within the spirit and scope of the invention.

Although aspects, embodiments, and/or examples have been illustrated and described herein, a person of ordinary skill in the art may identify alternative and/or equivalent variations capable of achieving the same or similar results, and such variations may be substituted for the aspects, embodiments, and/or examples illustrated and described herein without departing from the scope of the invention. Therefore, the scope of this application is intended to cover such alternative aspects, embodiments, and/or examples. Hence, the scope of the invention is defined by the accompanying claims and their equivalents. Further, each and every claim is incorporated as further disclosure into the specification.

What is claimed is:

1. A processor-implemented or computer-implemented method for resolving inconsistency within an evolving information structure through coupled state-transition processing, the method comprising:
(a) receiving or forming a machine-processable information structure comprising structural components including a plurality of elements and relationships among the elements;
(b) identifying relationships among said elements;
(c) detecting at least one inconsistency within said information structure based on a defined incompatibility condition;
(d) determining, from a plurality of candidate transformations and under defined process conditions, a subset of candidate transformations permitted for application to the information structure, wherein the subset is determined with respect to an inconsistency measure of the information structure;
(e) selecting, from the permitted subset of candidate transformations, at least one candidate transformation that reduces the inconsistency measure of the information structure under the defined process conditions;
(f) applying the selected candidate transformation to modify the information structure;
(g) iteratively repeating steps (c)-(f), wherein each repeated iteration operates on the information structure as modified by a selected candidate transformation applied in a preceding iteration, until a termination condition is satisfied, wherein the termination condition corresponds to a state in which no further permitted candidate transformations that reduce the inconsistency measure remain available under the defined process conditions; and
(h) outputting the resulting information structure.

2. A system comprising:
a memory storing a machine-processable information structure; and
a processor configured to:
(i) detect at least one inconsistency within the information structure based on a defined incompatibility condition;
(ii) determine, from a plurality of candidate transformations and under defined process conditions, a subset of candidate transformations permitted for application to the information structure, wherein the subset is determined with respect to an inconsistency measure of the information structure;
(iii) select, from the permitted subset of candidate transformations, at least one candidate transformation that reduces the inconsistency measure of the information structure under the defined process conditions;
(iv) apply the selected candidate transformation to modify the information structure;
(v) iteratively repeat inconsistency detection, determination of the permitted subset, transformation selection, and transformation application until a termination condition is satisfied, wherein the termination condition corresponds to a state in which no further permitted candidate transformations that reduce the inconsistency measure remain available under the defined process conditions; and
(vi) output a resulting information structure.

3. The method of claim 1, wherein determining the permitted subset comprises applying a candidate transformation to a copy, staged update, simulation state, temporary structure, transaction state, rule-evaluation state, or other test representation of the information structure to produce a test information structure, evaluating defined incompatibility conditions over the test information structure to create active test inconsistency records, calculating a post-transformation inconsistency measure for the test information structure, and including the candidate transformation in the permitted subset only when the post-transformation inconsistency measure is lower than the inconsistency measure of the information structure before application of the candidate transformation.

4. The method of claim 1, wherein calculating the inconsistency measure comprises evaluating a plurality of defined incompatibility conditions at corresponding loci of the information structure and calculating a count or weighted count of active detected incompatibility-condition violations, wherein each violation is determined by a violation indicator indicating whether a corresponding incompatibility condition is violated at a corresponding locus, and wherein a reduction value for a candidate transformation is calculated based on a difference between the inconsistency measure of the information structure before application of the candidate transformation and a post-transformation inconsistency measure of a test information structure produced by applying the candidate transformation to a copy or test representation of the information structure.

5. A processor-implemented or computer-implemented method for generating a traceable inconsistency-resolution record, comprising:
(a) receiving or accessing a machine-processable information structure comprising elements and relationships;
(b) detecting, by a processor, at least one inconsistency within the information structure based on a defined incompatibility condition;
(c) calculating an inconsistency measure for the information structure;
(d) identifying a plurality of candidate transformations associated with the detected inconsistency;
(e) applying one or more candidate transformations to one or more test representations of the information structure to calculate respective post-transformation inconsistency measures;
(f) determining, under defined process conditions and with respect to the inconsistency measure, a permitted subset of candidate transformations;
(g) selecting, from the permitted subset, a candidate transformation that reduces the inconsistency measure;
(h) applying the selected candidate transformation to modify the information structure;
(i) iteratively repeating steps (b)-(h) until a termination condition is satisfied, wherein the termination condition corresponds to a state in which no further permitted candidate transformations that reduce the inconsistency measure remain available under the defined process conditions;
(j) generating, for at least one iteration, a state-transition trace record identifying at least the detected inconsistency, the inconsistency measure before applying the selected candidate transformation, at least one tested candidate transformation, a post-transformation inconsistency measure associated with the tested candidate transformation, a reduction value associated with the tested candidate transformation, the permitted subset, the selected candidate transformation, the modified information structure, and a termination status; and
(k) outputting the modified information structure together with the state-transition trace record.

6. The method of claim 1, further comprising generating a state-transition trace record for at least one iteration of the method, the state-transition trace record identifying a current information structure, at least one detected inconsistency, an inconsistency measure before application of the selected candidate transformation, the selected candidate transformation, and an updated information structure produced by applying the selected candidate transformation.

7. The method of claim 6, wherein the information structure comprises a structured reasoning-state structure associated with an artificial-intelligence system, and wherein the state-transition trace record identifies a detected inconsistency between at least two of a user instruction, system constraint, model-generated proposition, tool output, memory fact, candidate action, planned operation, or retrieved fact.

8. The method of claim 1, wherein the information structure comprises a structured reasoning-state structure associated with an artificial-intelligence system, and wherein the permitted subset excludes a candidate transformation corresponding to a model-generated action, planned operation, tool call, or reasoning-state update that fails to reduce the inconsistency measure under the defined process conditions.

9. The method of claim 1, wherein implementation-specific domain objects are represented within the machine-processable information structure as elements, implementation-specific associations, dependencies, constraints, classifications, or structural links are represented as relationships, and implementation-specific conflict rules are represented as defined incompatibility conditions evaluated over the elements and relationships.

10. The method of claim 1, wherein determining the permitted subset comprises including a candidate transformation in the permitted subset only when the candidate transformation is associated with at least one active inconsistency record, produces a valid test information structure, satisfies the defined process conditions applicable to the candidate transformation, the information structure, or the test information structure produced by applying the candidate transformation, and reduces the inconsistency measure.

11. The method of claim 1, wherein the termination condition is reached in a finite number of iterations when the inconsistency measure is bounded over a finite or discrete state space, permitted candidate transformations under the defined process conditions enforce monotonic descent with respect to the inconsistency measure, and the set of permitted candidate transformations available for the current information structure at a given iteration is finite under the defined process conditions.

12. The method of claim 4, wherein the candidate transformation is excluded from the permitted subset when a reduction value associated with the candidate transformation is less than or equal to zero and is eligible for inclusion in the permitted subset only when the reduction value is greater than zero.

13. The method of claim 1, wherein selecting the permitted candidate transformation from the permitted subset comprises applying a deterministic selection rule, global evaluation metric, or predefined tie-breaking procedure to reduce divergence caused by arbitrary transformation ordering under the defined process conditions.

14. The method of claim 1, wherein the information structure comprises at least one of an access-control structure, entitlement structure, knowledge-graph structure, configuration structure, cloud-deployment structure, policy-rule structure, compliance structure, logical proposition structure, structured reasoning-state structure associated with an artificial-intelligence system, support-system structure, journaling-support structure, coaching-support structure, workflow-support structure, decision-support structure, behavioral-context structure, or user-context structure.

15. The method of claim 13, wherein the deterministic selection rule comprises selecting a candidate transformation that produces a lowest post-transformation inconsistency measure among candidate transformations in the permitted subset, and wherein a predefined tie-breaking procedure is applied when two or more candidate transformations produce the same post-transformation inconsistency measure.

16. The method of claim 1, wherein receiving the plurality of elements comprises converting received input text, structured records, semi-structured records, tool output, model output, policy data, configuration data, graph data, proposition data, or other machine-processable or machine-convertible input into the machine-processable information structure by forming input units, classifying the input units, and creating element records comprising element identifiers, text or value fields, element types, attributes, source data, and status data.

17. The method of claim 1, wherein identifying relationships among said elements comprises creating relationship records, each relationship record identifying a source element, a target element, a relationship type, a relationship basis, a status, or one or more relationship attributes.

18. The method of claim 6, wherein the state-transition trace record identifies at least one candidate transformation excluded from the permitted subset and associates the exclusion with failure to satisfy an association condition, a valid-structure condition, a defined process condition, or a reduction condition requiring reduction of the inconsistency measure.

19. The method of claim 6, wherein the state-transition trace record includes a termination status indicating that the resulting information structure is resolved when no active inconsistency remains, or stable with remaining inconsistency when no further permitted candidate transformation that reduces the inconsistency measure remains available under the defined process conditions.

20. The system of claim 2, wherein the processor is further configured to generate a state-transition trace record identifying, for at least one iteration, the detected inconsistency, the inconsistency measure before application of the selected candidate transformation, the permitted subset of candidate transformations, the selected candidate transformation, an updated information structure, a termination status, and candidate-test data identifying one or more tested candidate transformations, a test information structure produced for each tested candidate transformation, and a post-transformation inconsistency measure associated with the test information structure.

21. The method of claim 1, wherein the information structure comprises an access-control or entitlement structure including users, roles, groups, permissions, resources, grants, denials, inherited permissions, or policy constraints, and wherein the defined incompatibility condition corresponds to an incompatible entitlement, mutually exclusive role assignment, separation-of-duty violation, contradictory access state, conflicting allow-and-deny state, stale access state, or unsatisfiable policy-governed assignment.

22. The method of claim 1, wherein the information structure comprises a configuration, deployment, orchestration, or infrastructure structure including services, components, versions, dependencies, regions, resources, deployment conditions, configuration objects, runtime settings, or resource assignments, and wherein the defined incompatibility condition corresponds to an incompatible dependency, invalid resource assignment, region-policy conflict, port collision, mutually unsatisfiable deployment state, incompatible version condition, or contradictory configuration relation.

23. The method of claim 1, wherein the information structure comprises a knowledge-graph structure including entity nodes, attribute nodes, relationship edges, source records, classifications, timestamps, confidence values, or graph constraints, and wherein the defined incompatibility condition corresponds to an incompatible classification, contradictory entity attribute, invalid relationship edge, incompatible status value, conflicting entity-identity assignment, or graph-constraint violation.

24. The method of claim 1, wherein the information structure comprises a policy-rule, governance, compliance, or enforcement structure including governed entities, rules, permissions, prohibitions, conditions, approval requirements, enforcement states, audit constraints, or compliance constraints, and wherein the defined incompatibility condition corresponds to conflicting allow-and-deny rules, prohibited operational states, contradictory rule effects, mutually unsatisfiable policy conditions, or a configuration state conflicting with a policy requirement.

25. The method of claim 6, wherein the state-transition trace record further identifies one or more candidate transformations tested against a copy or test representation of the current information structure, a post-transformation inconsistency measure calculated for a test information structure produced by applying each tested candidate transformation to the copy or test representation, and the permitted subset of candidate transformations determined under the defined process conditions and with respect to the inconsistency measure.

26. The method of claim 1, wherein the inconsistency measure comprises a normalized inconsistency measure on a bounded scale, wherein a lower value indicates lower detected inconsistency and a higher value indicates higher detected inconsistency under a defined reference scale applicable to the information structure, and wherein, in one embodiment, the bounded scale is a scale from 0 to 100 in which 0 indicates that no active inconsistency is detected under the defined incompatibility conditions and 100 indicates a maximum or reference inconsistency value under the defined reference scale.

27. The method of claim 1, further comprising, before detecting said at least one inconsistency, converting received input data into the machine-processable information structure by organizing received elements, constraints, state descriptors, or relationships into a representation suitable for evaluation under the defined incompatibility condition.

28. The method of claim 1, wherein the information structure comprises a logical proposition structure including propositions, rules, implications, negations, constraints, assertions, support relationships, contradiction relationships, mutual-exclusion relationships, or dependency relationships, and wherein the defined incompatibility condition corresponds to a logical contradiction, violated implication constraint, mutually exclusive proposition pair, rule conclusion conflicting with a constraint, or proposition violating a defined incompatibility condition.

29. The method of claim 1, wherein the information structure is represented as a graph comprising nodes corresponding to elements and edges corresponding to relationships among the elements.

30. The method of claim 1, wherein the defined incompatibility condition comprises a logical contradiction between elements.

31. The method of claim 1, further comprising, before detecting said at least one inconsistency, determining whether the machine-processable information structure satisfies a predefined condition indicating that inconsistency-resolution processing should be performed under the defined process conditions.

32. The method of claim 1, wherein the candidate transformations include one or more of removal of an element, modification of an element, substitution of an element, deactivation of an element, removal of a relationship, relabeling of a relationship, splitting of an element, merging of elements, quarantining of an element, marking of an element or action as non-permitted, substituting a dependency, or reassigning a resource.

33. The system of claim 2, wherein selecting from the permitted subset of candidate transformations comprises rule-based transformation selection.

34. The method of claim 6, further comprising outputting the state-transition trace record with the resulting information structure, wherein the state-transition trace record is stored, displayed, returned through an application programming interface, supplied to a downstream software module, used to control a subsequent machine action, or used as an updated reasoning-state structure.

35. The method of claim 1, further comprising storing the resulting information structure in memory before outputting the resulting information structure.

36. A non-transitory computer-readable medium storing instructions that, when executed by one or more processors, cause the one or more processors to perform the method of any one of claims 1, 3-19, 21-32, 34, and 35.
